(19) United States
(12) Patent Application Publication
(10) Pub. No.: US 2008/0080037 A1
(43) Pub. Date: Apr. 3, 2008

(54) Precisely Actuating Member and Image Tilting Device and Projection System Having Them

(76) Inventors: Hyeong-Ryeol Oh, Seoul (KR); Jae Wook Kyu, Seoul (KR)

Correspondence Address: KELLEY DRYE & WARREN LLP, 3050 K STREET, NW, SUITE 400, WASHINGTON, DC, 20007, US

(21) Appl. No.: 10/574,564

(22) PCT Filed: Nov. 8, 2003
(86) PCT No.: PCT/KR04/02843

§ 371 Date: May 30, 2007

(30) Foreign Application Priority Data
Nov. 8, 2003 (KR) 10-2003-007898906
Nov. 17, 2003 (KR) 10-2003-0081004
Nov. 17, 2003 (KR) 10-2003-0081007

(51) Int. Cl. G02B 26/08

(52) U.S. Cl. 359/225

(57) ABSTRACT

The present invention relates to a precisely actuating member and an image tilting device and a projection system having them, more particularly, to a projection system comprising a precisely actuating member formed in a one-piece unit to permit a precise rotation movement, an image tilting device for increasing the resolution by precisely adjusting the angle of an image, and a projection system having them. The image tilting device according to the preferred aspect of the present invention comprises a casing. The precisely actuating member is housed in the casing to be integrated therewith for precise reciprocation. A driving member contacts to the precisely actuating member for the movement of the actuating member. A light path conversion member is located on the precisely actuating member to convert the light path by a precise movement.

### BACKGROUND OF THE INVENTION

1. Field of the Invention

The present invention relates to a precisely actuating member and an image tilting device and a projection system having them, more particularly, to a projection system comprising a precisely actuating member which can rotate precisely by being integrated, an image tilting device for increasing the resolution by precisely adjusting the angle of an image, and a projection system having them.

2. Description of the Related Art

Projection systems are used to display small images on large screen by means of optical means, which are classified as a CRT (Cathode Ray Tube projection), a LCD (Liquid Crystal Display) projection, and a DLP (Digital Light Processing projection) according to the kind of images display element.

A CRT projection system, which is the oldest method, displays images on a screen by reflecting images of a small high-resolution cathode ray tube onto a mirror.

In an LCD projection system, a small LCD of the size of about 4 inches within a projection TV receives the outside regeneration image signals sent to the projection TV to reproduce the images. Thereafter, the images displayed on a screen is exposed by a strong beam behind the liquid crystal display so that the display is magnified and reflected on a mirror to be projected on the screen.

A DLP projection system operates in such a way as to magnify and project image signals inputted from the outside by use of DMD (Digital Micromirror Device) semiconductor chip in which hundreds of thousands of minutely actuating mirrors invented by Texas Instrument, Inc. are integrated.

Such DLP projection system is disclosed in U.S. Pat. No. 6,582,080 of Imax Corporation.

FIG. 1 shows schematically the principal element of a projection system in accordance with the prior art. Reference numeral 20 represents a light source which projects a beam of light 22 on a projection screen 24 via a projection lens 26. The light beam 22 is optically split into red, green and blue components (R, G, B) by a beamsplitter comprising an assembly of prisms 30. The respective components are directed to three corresponding DMDs 32 by the beamsplitter.

The DMDs are essentially identical but deal with different portions of the spectrum. In other words, the light that enters the beamsplitter is split into red, green and blue components, which are delivered to the respective R, G and B DMDs. The beamsplitter then in effect re-assembles the R, G and B components of the light beam and directs them together into the projection lens 26 for projection onto the screen 24.

Each of the DMDs 32 comprises an array of reflective digital light switches (mirrors) that are integrated onto a silicon chip capable of addressing the switches individually. Each switch represents a single pixel in the array and can be individually switched on or off in accordance with digital information that is provided to the chip by an appropriate hardware and software controller. Each individual pixel in each DMD is controlled to impart appropriate image information to the light beam that is projected onto the screen 24.

However, since the projection system in accordance with the prior art basically magnifies and projects original small images to be displayed on a large screen, it has a disadvantage that the image quality of the enlarged images necessarily degrades substantially compared with the original images.

In addition, the DLP projection system in accordance with the prior art has a problematic disadvantage that the image quality degrades due to an optical illusion. The optical illusion, which is a phenomenon not photographed but visible only to human eyes, degrades the image quality, when the images or human eyes move fast, for example, the rainbow colors are seen on the spot of a high contrast ratio such as a black band on a white background, or when grid patterns between respective pixels are contrasted due to the fast eye movement.

### SUMMARY OF THE INVENTION

The present invention is to resolve the above-mentioned problems. It is an object of the present invention to provide a precisely actuating device formed in a one-piece unit capable of micro-rotating images without loss of driving force or unnecessary clearance.

It is another object of the present invention to provide an image tilting device capable of increasing the resolution by precisely adjusting the angles of images.

It is another alternative object of the present invention to provide an image tilting device comprising a precisely actuating device, which is integrated to precisely rotate the images without loss of driving force or unnecessary clearance.

It is another alternative object of the present invention to provide a projection system capable of improving the image quality, comprising an image tilting device capable of precisely adjusting the angles of images.

### BRIEF DESCRIPTION OF THE DRAWINGS

The above objects and advantages of the present invention will become more apparent by describing in detail the preferred embodiments thereof with reference to the attached drawings, in which:

FIG. 1 is a schematic view showing a projection system as known in the prior art.

FIG. 2 is a schematic sectional view showing a rotation device as known in the prior art.

FIGS. 3 and 4 are schematic sectional views showing a precisely actuating member in accordance with one aspect of the present invention.

FIG. 5 is a perspective view showing an image tilting device in accordance with another aspect of the invention.

FIGS. 6 and 7 are schematic sectional views showing a precisely actuating member applied to an image tilting device in accordance with another aspect of the present invention.

FIG. 8 is a schematic view showing the mode of operation of the precisely actuating member illustrated in FIGS. 6 and 7.

FIG. 9 is a schematic perspective view showing a modification of a precisely actuating member applied to the image tilting device in accordance with another aspect of the present invention.

FIG. 10 is a schematic sectional view showing a piezoelectric driving element applied to the image tilting device in accordance with another aspect of the present invention.

FIG. 11 is a schematic view showing the principle of operation of an electromagnetic driving element applied to the image tilting device in accordance with another aspect of the present invention.

FIGS. 12 and 13 are schematic views showing a variation on an electromagnetic driving element applied to the image tilting device in accordance with another aspect of the present invention.

FIG. 14 is a schematic sectional view showing another variation on the electromagnetic driving element applied to the image tilting device in accordance with another aspect of the present invention.

FIGS. 15 and 16 are schematic sectional views showing another variation on a precisely actuating member applied to the image tilting device in accordance with another aspect of the present invention.

FIG. 17 is a schematic view showing a variation on a light path conversion member applied to the image tilting device in accordance with another aspect of the present invention.

FIG. 18 is a schematic view showing another variation on the light path conversion member applied to the image tilting device in accordance with another aspect of the present invention.

FIG. 19 is a schematic perspective view showing the image tilting device illustrated in FIG. 18.

FIG. 20 is a schematic view showing the principle of the light path conversion member applied to the image tilting device illustrated in FIG. 18.

FIG. 21 is an exploded perspective view showing a variation on the image tilting device in accordance with another aspect of the invention.

FIG. 22 is a perspective view showing the casing illustrated in FIG. 21.

FIGS. 23 and 24 are perspective views showing the precisely actuating member illustrated in FIG. 21.

FIGS. 25 and 26 are sectional views showing the precisely actuating member illustrated in FIG. 21.

FIG. 27 is a perspective view showing the pre-pressure spring illustrated in FIG. 21.

FIGS. 28 and 29 are perspective views showing the frame illustrated in FIG. 21.

FIG. 30 is a perspective view showing the supporting member illustrated in FIG. 21.

FIG. 31 is a perspective view showing a fastening spring illustrated in FIG. 21.

FIG. 32 is a perspective assembly view showing a precisely actuating member and a light path conversion member of the image tilting device in accordance with another aspect of the present invention.

FIG. 33 is a schematic view showing a first embodiment of the projection system in accordance with another alternative aspect of the present invention.

FIGS. 34 and 35 are schematic views showing the principle of the increase of the visible resolution of the projection system illustrated in FIG. 33.

FIG. 36 is a schematic view showing a second embodiment of the projection system in accordance with another alternative aspect of the present invention.

FIGS. 37 and 38 are schematic views showing the principle of the increase of the visible resolution of the projection system illustrated in FIG. 36.

FIG. 39 is a schematic view showing a third embodiment of the projection system in accordance with another alternative aspect of the present invention.

FIGS. 40 and 41 are schematic views showing the principle of the increase of the visible resolution of the projection system illustrated in FIG. 39.

FIGS. 42 to 51 are graphs showing a control wave generated by a control-wave generating device of the projection system illustrated in FIG. 39, and showing a variation of angles of the image tilting device driven by the control wave.

FIGS. 52 and 53 are schematic views showing the principle of the increase of the visible resolution of the projection system illustrated in FIG. 39.

FIGS. 54 and 55 are graphs showing a control wave generated by the control-wave generating device of the projection system illustrated in FIG. 39, and showing the variation of angles of the image tilting device driven by the control wave.

### DETAILED DESCRIPTION OF THE INVENTION

In order to achieve the above-mentioned objects, in one aspect, the present invention provides a precisely actuating member, comprising a predetermined plate-shaped support portion; a hinge portion of bottleneck structure extending vertically upward which is integrated with the support to runs from one end to another end of the support; a rotating portion which is integrated with the support portion and the hinge portion, is connected by the hinge portion to be disposed above the support portion, precisely reciprocates and rotates right and left on the axis of the hinge portion.

In order to achieve the above-mentioned objects, in another aspect, the present invention provides an image tilting device comprising a precisely actuating means which is housed within the casing and is integrated so as to reciprocate precisely; a driving means which disposes contactably with the precisely actuating device to cause the precisely actuating device to drive; and a light path conversion means which is disposed above the precisely actuating member to convert a light path by a precise movement of the precisely actuating device.

The precisely actuating member comprises a predetermined plate-shaped support portion; a first hinge portion of bottleneck structure extending vertically upward which runs from one end to another end of the support portion; and a rotating portion which is connected by the hinge portion to be disposed above the support portion, and precisely reciprocates and rotates right and left on the axis of the first hinge portion.

The precisely actuating member may further comprise an adjustment screw for adjusting the initial angles of the support portion and the rotating portion, a pre-pressure spring for controlling the pre-pressure of the support portion and the rotating portion, a plurality of balls for point contact.

The driving means may comprise a piezoelectric driving element and an electromagnetic driving element.

The electromagnetic driving element may comprise a yoke of a predetermined shape for easily generating an electromagnetic force, which is attachable to the precisely actuating member; a permanent magnet, which is attached to the yoke to form a magnetic field; an electric wire arranged between the yoke and the permanent magnet to form a magnetic field with the permanent magnet.

The precisely actuating member comprising the electromagnetic driving element may comprise at least one connection portion, which contact with the electromagnetic driving element to transmit the mechanical energy of the electromagnetic driving element to the precisely actuating member.

The image tilting device comprises a protrusion portion to support the light path conversion means at one face, and may further comprise a frame of a predetermined height, and a supporting member which is covered over the other side of the protrusion portion of the frame to prevent the light path conversion means interposed into the frame from bending.

The image tilting device may further comprise a frame of the light path conversion means and a fastening spring for fixedly mounting the supporting member above the precisely actuating device.

The image tilting device may further comprise a control wave generation means, which generates a control wave to control the movement of the precisely actuating device.

In order to achieve the above-mentioned objects, another alternative aspect of the present invention provides a projection system comprising a light source generating a white light; a color processing means for imparting a predetermined color to the white light from the light source; a micro display means for displaying a predetermined image by use of the light processed by the color processing means; at least one projection lens for projecting the images displayed on the micro display means; an image tilt means which receives and precisely rotates the images projected from the projection lens at a predetermined angle, and converts the image projection path to transmit; and a screen for enlarging and displaying the images rotated precisely by the image tilting device.

The projection system may further comprise an optical means for picturizing the light processed by the color-processing device.

Hereinafter, the precisely actuating device, the image tilting device, and the projection system having them in accordance with the preferred aspect of the present invention will be described in detail with reference to the accompanying drawings. For it easier comprehension, the same reference numbers were used for identical components in the different figures wherever possible.

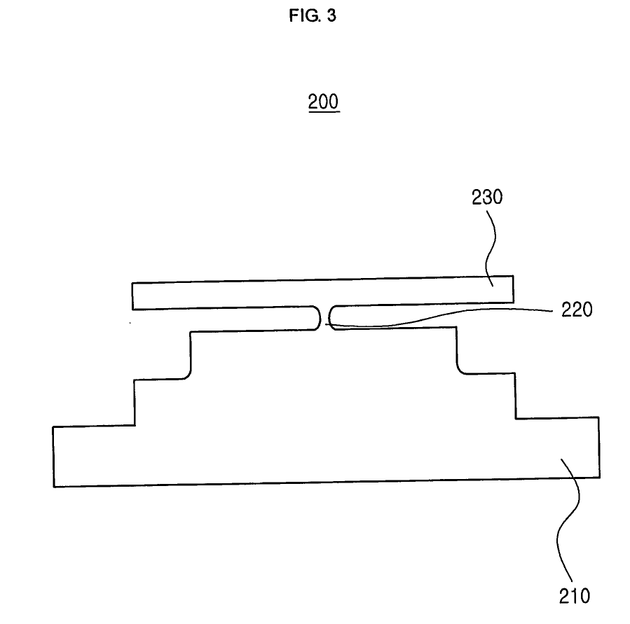

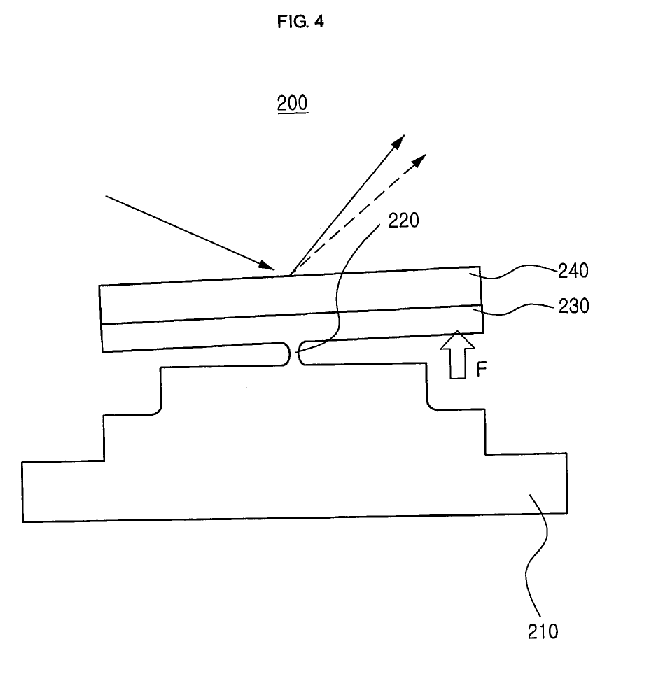

FIGS. 3 and 4 are schematic sectional views of the precisely actuating member of one aspect of the present invention.

Referring to FIGS. 3 and 4, the precisely actuating member 200 in accordance with one aspect of the present invention comprises a predetermined plate-shaped support portion 210; a hinge portion 220 of bottle neck structure extending vertically upward which is integrated with said support portion and runs from one end to another of said support portion 210; a rotating portion 230 integrated with the support portion 210 and the hinge 220, which is connected by the hinge portion 220 to be disposed above the support portion 210 and precisely reciprocates and rotates right and left at the center of the hinge portion 220 in a reciprocating manner.

The support portion 210, the hinge portion 220 and the rotating portion 230 are integrated by a same material, which is preferably formed of aluminum or plastic having an elastic restoring force.

The support portion 210 is configured such that predetermined plate-shaped members are overlapped in a layer structure, wherein another hinge portion may be formed between the overlapped plate-shaped members.

The hinge portion 220 has a bottleneck structure formed in such a manner that both sides of a rectangular rod are trimmed symmetrically at a predetermined diameter. The portion of the thinnest thickness in the bottleneck structure is the shape of a thin plate, which acts as a plate spring.

The rotating portion 230, which is a predetermined plate-shaped member, rotates precisely at the center of the hinge portion 220 when an external force F is applied to one end thereof as shown in FIG. 4.

Since the precisely actuating member 200 is integrated by a material having an elastic restoring force, the rotating portion 230 precisely rotates at the center of the hinge portion 220 when an external force is applied by any driving element. At this time, the rotating portion 230 precisely rotates continuously until the external force, which is applied to the rotating portion 230 by the elasticity of the hinge portion 220, is counteracted to disappear or is removed.

A mirror 240 may be attached above the rotating portion 230. If an external force is applied to the precisely actuating member 200 attached to the mirror 240, the mirror 240 attached to the rotating portion 230 precisely rotates together, whereby the light reflecting on the mirror 240 or a given image continuously rotate precisely according to the variation of angle of the precisely-rotating mirror as shown by the arrows.

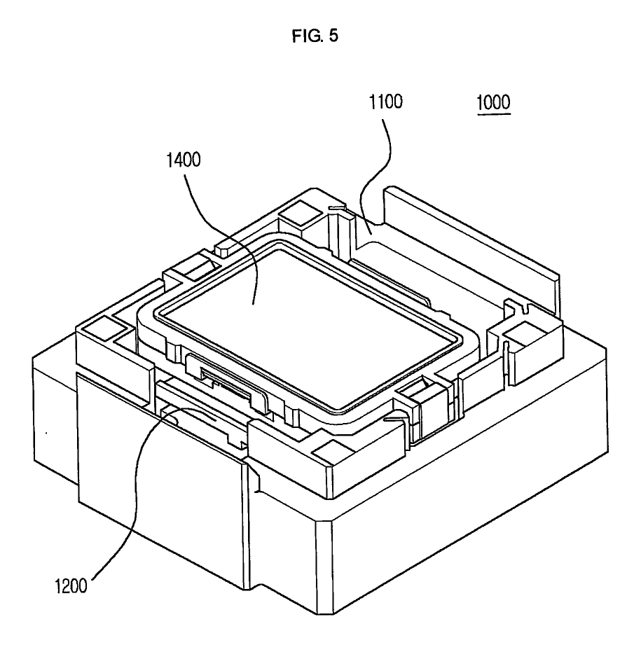

Referring to FIG. 5, the image tilting device 1000 in accordance with another aspect of the present invention comprises a casing 1100; a precisely actuating member 1200 which is housed within the casing 1100 and is formed integrally so as to reciprocate precisely; a driving member (not shown) which contacts to the precisely actuating member 1200 to cause the precisely actuating member to drive; and a light path conversion member 1400 capable of converting a light path by the precise movement of the precisely actuating member.

The casing 1100 is of a rectangular parallelepiped shape having a predetermined space therewithin with its upper portion open.

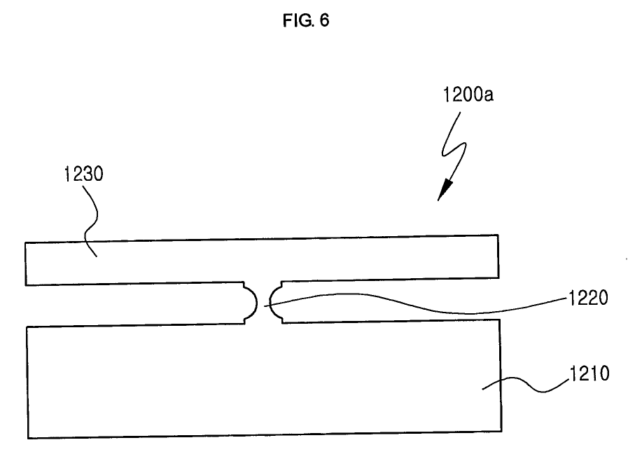

FIGS. 6 to 9 show the precisely actuating member 1200 applied to the image tilting device in accordance with another aspect of the present invention.

FIGS. 6 to 9 are schematic views showing the precisely actuating member 1200a applied to the image tilting device in accordance with another aspect of the present invention.

Referring to FIGS. 6 to 9, the precisely actuating member 1200a comprises a predetermined plate-shaped support portion 1210; a first hinge portion 1220 of a bottleneck structure extending vertically upward which runs from one end to another end of the support portion 1210; a rotating portion 1230 which is connected by the hinge portion 1220 to be disposed above the support portion 1210, and precisely reciprocates and rotates right and left at the center of the first hinge portion 1220.

The support portion 1210, the first hinge portion 1220, and the rotating portion 1230 are integrated by a same material, which is preferably made of aluminum or plastic having an elastic restoring force.

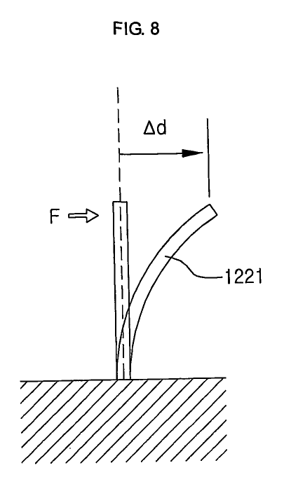

The rotating portion 1230 rotates at the center of the first hinge portion 1220 when an external force F is applied to one end thereof as shown in FIG. 8.

The first hinge portion 1220 is of a bottleneck structure formed in such a manner that both sides of a rectangular rod are symmetrically trimmed at a predetermined radius. The thinnest portion of the bottleneck structure is of the shape of a thin plate, acting as a plate spring.

FIG. 8 shows the manner of operation of the plate spring 1221.

The plate spring 1221, if an external force F is applied to one side thereof, is deformed in the direction of the force application generate a displacement Δd. The relationship between the external force F and the displacement Δd depends on the material, thickness, extent of the plate spring 1221 and the point of application of the external force. If the displacement Δd is very small, the displacement Δd and the external force F have a proportional relation.

In addition, if the displacement Δd is within the range of elastic limit of the plate spring 1221, the plate spring 1221 is restored to its original state by its restoring force if the external force F is removed.

The plate spring 1221 is deformable by a small force with respect to the external force F applied to both sides of the plate, but is not easily deformed since the plate spring 1221 has a strong rigidity with respect to other directions.

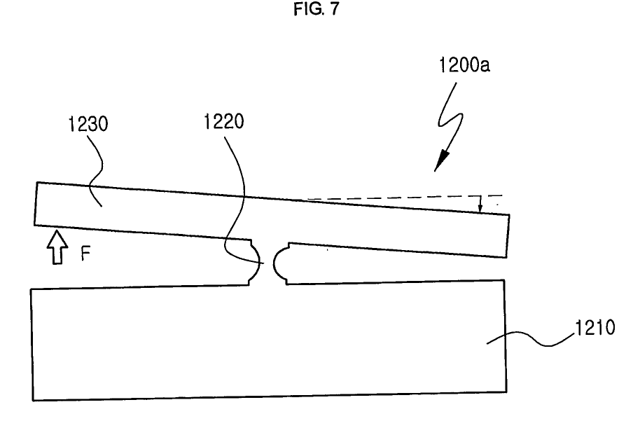

Accordingly, due to the manner of operation of the plate spring 121, the precisely actuating member 1200a of FIGS. 6 and 7 can precisely rotate right and left at the center of the bottleneck structure of the first hinge portion 1220 within the elastic limit of the first hinge portion 1220.

Also, since the precisely actuating member 1200a is integrated with a same material having an elastic restoring force, the uncertainty between the external force applied and the displacement is minimized since there is neither mechanical friction nor clearance unlike an assembled apparatus.

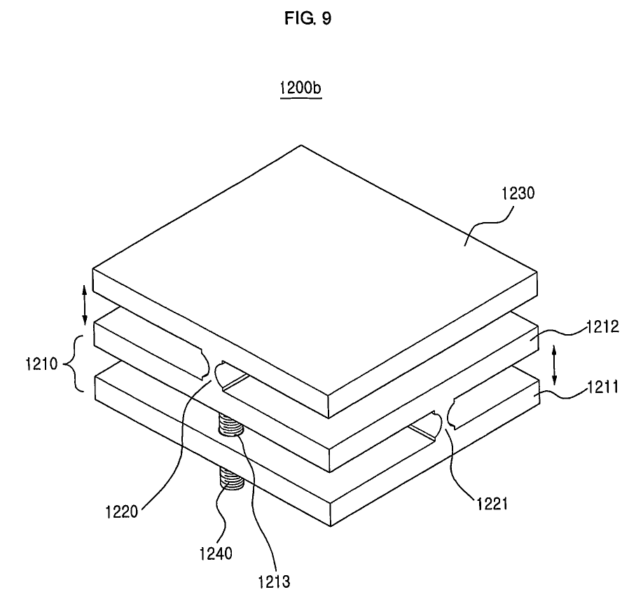

FIG. 9 is a schematic perspective view of a variation on a precisely actuating member applied to the image tilting device in accordance with another aspect of the present invention.

Referring to FIG. 9, the precisely actuating member 1200b comprises a predetermined plate-shaped support portion 1210; a first hinge portion 1220 of a bottleneck structure extending vertically upward which runs from one end to another end of the support portion 1210; and a rotating portion 1230 which is connected by the hinge portion 1220 to be disposed above the support portion 1210 and precisely and rotates right and left at the center of the first hinge portion 1220.

The precisely actuating member 1200b comprises a plurality of support portions, wherein the plurality of support portions are composed of a first support portion 1211 and a second support portion 1212, runs from one end to another end, and are connected upwardly and downwardly by the second hinge portion 1222 of a bottleneck structure which extends vertically upward. At this time, the second hinge portion 1222 is perpendicular to the first hinge portion 1220.

The first support portion 1211, the second support portion 1212, the rotating portion 1230, the first hinge portion 1220 and the second hinge portion 1222 are integrated by the materials having an elastic restoring force.

The precisely actuating member 1200b may further comprise support portion 1210 between respective plate-shaped members, an adjustment screw 1240 for adjusting the initial angle of the rotating portion 1230, and a pre-pressure spring not shown for adjusting the pre-pressure of the rotating portion 1230.

The first support portion 1211 and the second support portion 1212, as shown by the arrow, can precisely rotate at the center of the second hinge portion 1222 connecting them. The rotating portion 1230 can precisely rotate at the center of the first hinge portion above the support portion 1210.

At this time, the first hinge portion 1220 and the second portion hinge 1222 is positioned perpendicularly to the respective length-direction, thereby adjusting the angle and rotation direction of each portion to different directions since the rotating portion 1230 of the precisely actuating member 1200b and the support portion 1210 precisely moves to the orthogonal direction with respect to each other.

The first support portion 1211 and the second support portion 1212 comprise at least one through hole 1213 for inserting the adjustment screw 1240 and/or the pre-pressure spring (not shown).

In addition, the first support portion 1211 and the second support portion 1212 further comprise a through hole for inserting the driving member (not shown) for the movement of the precisely actuating member 1200b through the support portion 1210 so as to be contactable with the rotating portion 1230.

The adjustment screw 1240 is inserted perpendicularly through the through hole 1213 to tilt the second support portion 1212 at a predetermined angle, thereby adjusting the angle of the precise rotation of the rotating portion 1230 positioned above the second support portion 1212.

The adjustment screw 1240 may be positioned so as to be in contact with the bottom surface of the second support portion 1212, or to be in contact with the bottom surface of the rotating portion 1230.

The pre-pressure spring (not shown) is positioned so as to be in contact with the bottom surface of the rotating portion 1230 through the through hole 1213 formed in the first support portion 1211, and the precisely rotated rotating portion 1230 is returned to its original position by the elastic restoring force of the pre-pressure spring as well as the elastic force of the first hinge portion 1220.

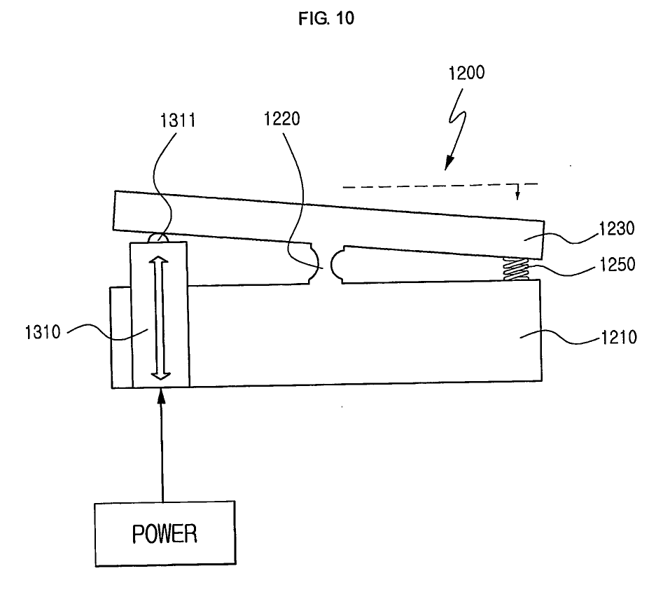

FIGS. 10 to 14 show the driving member applied to the image tilting device 1000 in accordance with another aspect of the present invention.

The driving member of the image tilting device 1000 in accordance with another aspect of the present invention, which is positioned between the support portion 1210 and the rotating portion 1230 of the precisely actuating device 1200, is a device for precisely rotating the rotating portion 1230 by contacting with the bottom surface of the rotating portion 1230.

The driving member may comprise a piezoelectric driving element 1310, which converts an electric energy to a mechanical energy to drive the precisely actuating member, and an electromagnetic driving element 1320, which generates a mechanical energy by a variation of magnetic field to precisely rotate the precisely actuating member 1200.

Referring to FIG. 10, the piezoelectric driving element 1310 applied to the image tilting device 1000 in accordance with another aspect of the present invention passes perpendicularly through the support 1210 to be inserted so that is in contact with the bottom surface of the rotating portion 1230.

The piezoelectric driving element 1310 generates an oscillation if voltage is applied, its length increasing at about 10 μm if 100 volts are applied. That is, the phenomenon is repeated that the length of the piezoelectric driving element 1310 increases at about 10 μm by the oscillation and then returns to its original state.

Since the piezoelectric driving element 1310 is in contact with the bottom surface of the rotating portion 1230 of the precisely actuating member 1200 as shown in FIG. 10, the precise movement of the piezoelectric driving element 1310 is transferred to the rotating portion 1230, whereby the rotating portion 1230 can also rotate precisely at the center of the hinge portion 1220 in a reciprocating manner.

The pre-pressure spring 1250 is positioned opposite to the piezoelectric driving element 1310 at the center of the hinge portion 1220, serving for the rotating portion 1230 rotated by the piezoelectric driving element 1310 to return to its original position.

The piezoelectric driving element 1310 may have a point contact structure with the rotating portion 1230 of the precisely actuating device 1200 in order to transmit the precise movement of the piezoelectric driving element 1310 based on one point more accurately. For such point contact structure, a ball 1311 is positioned on top of the piezoelectric driving element 1310 so that the movement of the piezoelectric driving element 1310 can be transmitted to the rotating portion 1230 by the ball 1311 without being dispersed.

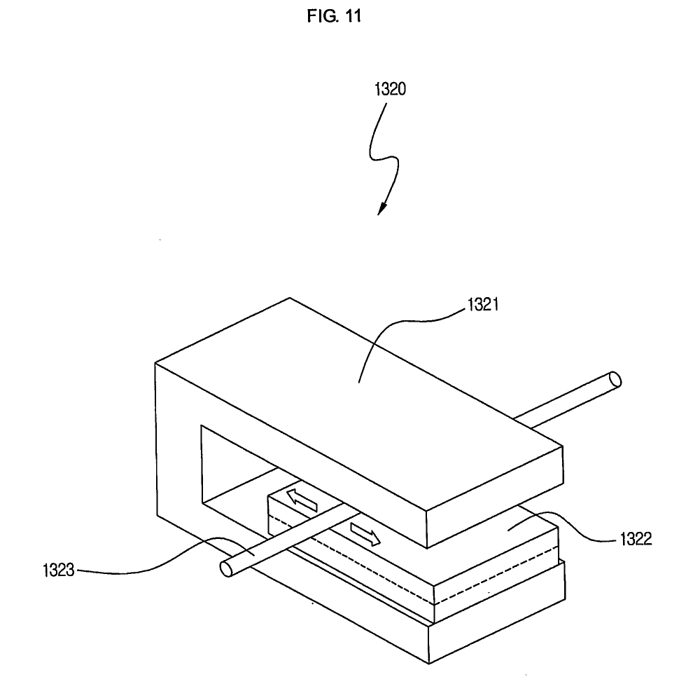

FIG. 11 shows the electromagnetic driving element 1320 applied to the image tilting device in accordance with another aspect of the present invention.

Referring to FIG. 11, the electromagnetic driving element 1320 is of a predetermined shape for easily generating the electromagnetic force, comprising a yoke 1321 attachable to the precisely actuating member 1200; a permanent magnet 1322 for forming an electric field by being attached to the yoke 1321; and an electric wire 1323 positioned between the yoke 1321 and the permanent magnet 1322 so as to form an electric field with the permanent magnet 1322.

The yoke 1321 of the predetermined shape has a plurality of branches positioned in parallel, being made of a metal-based material in order to form an electric field.

The yoke 1321 is provided with the permanent magnet 1322 on one side of branches, the upper and bottom surfaces of the permanent magnet 1322 having opposite polarities. Due to this structure, an electric field is formed perpendicularly to the surface attaching the permanent magnet 1322 between the branches of the yoke 1321 to which the permanent magnet 1322 is attached.

The electric wire 1323 is positioned so as to pass between the branches of the yoke 1321 to which the permanent magnet 1322 is attached. If an electric current is applied to the electric wire 1323, a force is applied to the arrow directions depending on the electric current direction by the interaction of the electric current and the permanent magnet 1322.

If the electromagnetic driving element 1320 as described above is disposed so as to be in contact with the rotating portion 1230 of the precisely actuating member 1200, the force of the electromagnetic driving element 1320 is transmitted to the precisely actuating member 1200 so that the rotating portion 1230 can precisely rotate in a reciprocating manner.

The electromagnetic driving element 1320 may be used as a coil with the electric wire 1323 wound around the branches of the yoke 1321 multiple times.

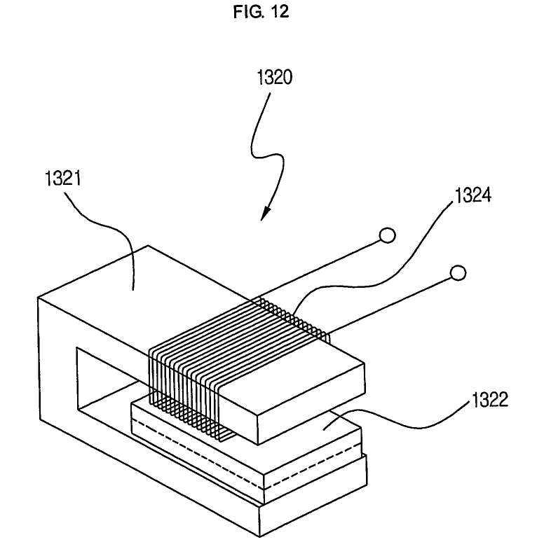

FIGS. 12 to 14 illustrates variations of the electromagnetic driving element 1320 applied to the image tilting device 1000 in accordance with another aspect of the present invention.

Referring to FIG. 12, the electromagnetic driving element is constructed such that the permanent magnet 1322 having different polarities at both sides is attached to one side of the branch of the yoke 1321, and a coil 1324 is wound multiple times around the opposite side of the branch to which the permanent magnet 1322 is attached. The coil 1324 generates the force proportional to the winding turns. In addition, the direction and magnitude of the force applied to the coil 1324 can be adjusted by adjusting the direction and magnitude of the electric current flowing between one end and the other end of the coil 1324.

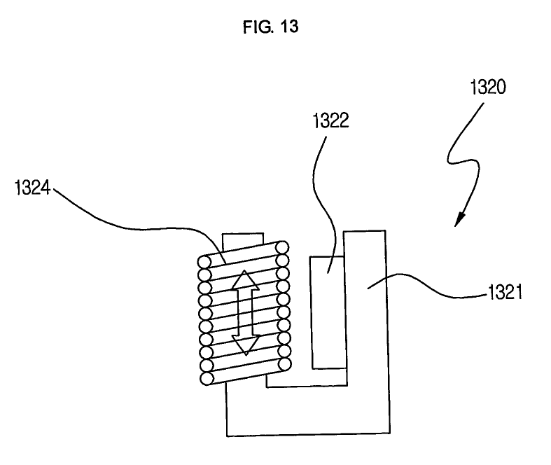

Referring to FIG. 13, the manner of the precise movement of the electromagnetic driving element 1320 wound by the coil 1324 will be described.

If an electric current is applied to the coil 1324 wound around the yoke 1321, the coil 1324 is given a force in the length direction of the branch of the yoke, perpendicular to the winding direction of the coil 1324 according to the direction of the electric current applied. Accordingly, if the direction of electric current is adjusted, the direction of the force applied to the coil 1324 changes. If such phenomenon is rapidly repeated, the electromagnetic driving element 1320 has such an effect as precisely oscillating.

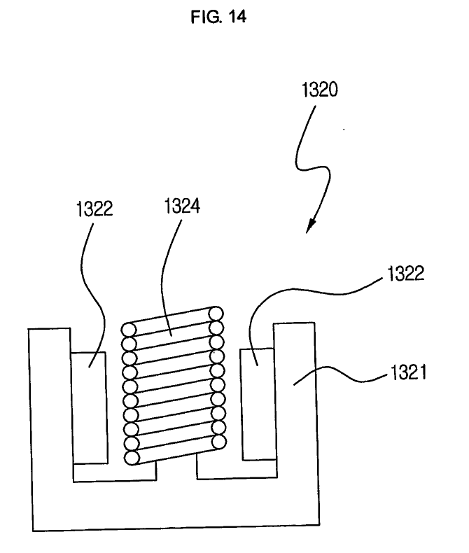

The electromagnetic driving element 1320, as the variation of FIG. 14, may have more branches of the yoke 1321.

The electromagnetic driving element 1320 having three branches of the yoke 1321 is configured such that the permanent magnet 1322 is attached to the branches positioned at both ends, and the coil 1324 is wound around the branch positioned at the center, as shown in FIG. 12.

In addition, the electromagnetic driving element having more than four branches not shown is constructed in such a manner that a permanent magnet is attached to the branches positioned at both ends, and the coil is wound around the remaining branches positioned at the center. If the permanent magnet attached and the coils increase as the branches increase, the driving force of the electromagnetic driving element increases accordingly.

Such an electromagnetic driving element 1320 as described above is constructed such that the branch is attached toward vertically upward to the ends of the rotating portion 1230 of the precisely actuating member 1200, like another variation of the precisely actuating member 1200 applied to the image tilting device 1000 in accordance with another aspect of the present invention.

The precisely actuating member 1200 further comprises a connection portion 1325, which is attached to the bottom surface of the rotating portion 1230 to contact with the electromagnetic driving element 1320, in order to transmit the driving force of the electromagnetic driving element 1320 to the rotating portion 1230. The connection portion 1325 is preferably formed integrally with the precisely actuating member 1200.

If an electric current is applied to the electromagnetic driving element 1320, the coil 1324 wound around the yoke 1321 is given a force in up and down directions, and then the force is transmitted through the contacting connection portion 1325 to the rotating portion 1230 of the precisely actuating member 1200. Thus, the precisely actuating member 1200 can precisely rotate up and down in a reciprocating manner.

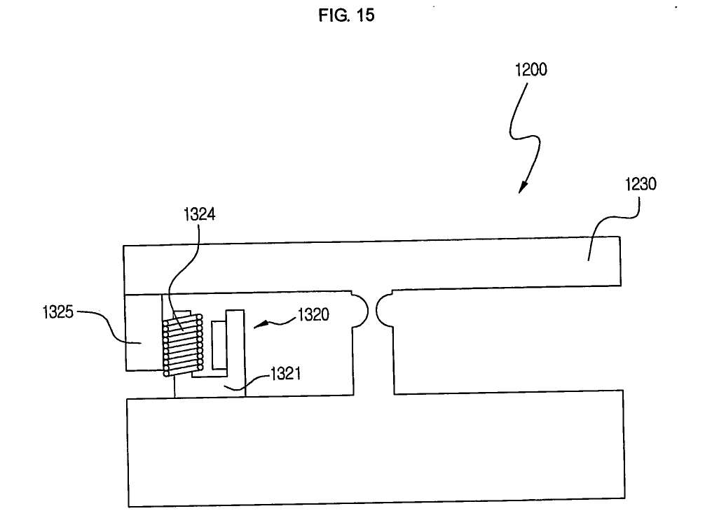

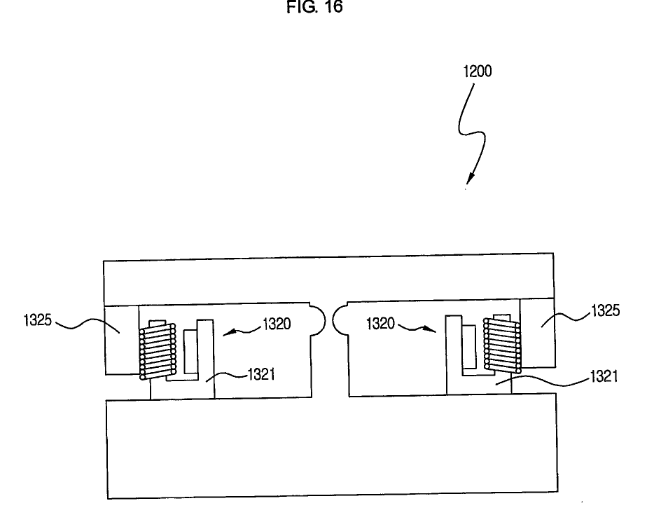

The electromagnetic driving element 1325, as shown in FIG. 15, may be positioned at one end of the precisely actuating member 1200, and may be positioned at both ends of the precisely actuating member 1200 in order to make the driving force of the electromagnetic driving element bigger, as shown in FIG. 16. Due to the multiple connection portions as shown in FIG. 16, the driving force of the electromagnetic driving element 1320 increases in proportion to the number of the electromagnetic driving element 1320.

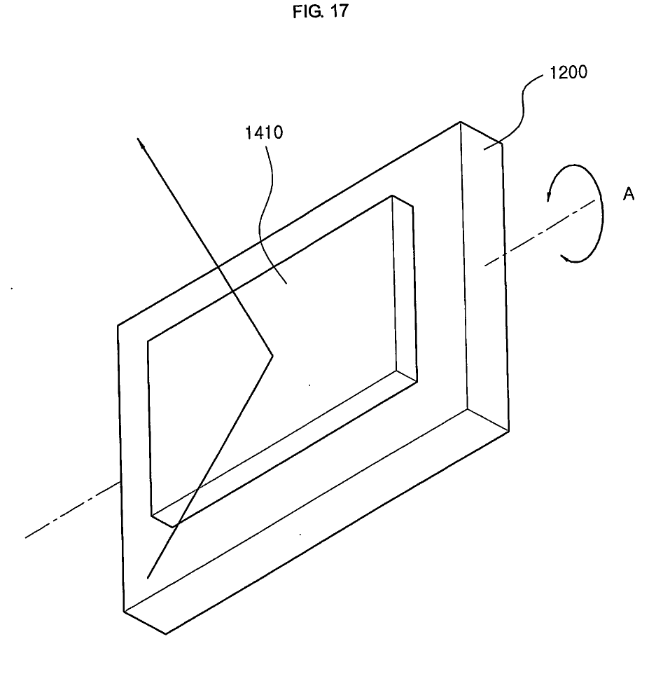

Referring to FIGS. 17 to 20, there is shown the light path conversion member applied to the image tilting device 1000 in accordance with another aspect of the present invention.

The light path conversion member is a device, which can convert the light path by the precisely reciprocating rotation of the precisely actuating member 1200, may comprise a reflecting mirror 1410 or a refracting plate 1420.

Referring to FIG. 17, the reflecting mirror 1410 reflects an incident light to the direction indicated by the arrow shown in FIG. 17, and at this time, the reflecting angle depends on the incident angle and the smoothness of the reflecting mirror 1410, etc.

In addition, the reflecting angle is also influenced by the direction of the precise rotation of the precisely actuating member 1200 attaching the reflecting mirror 1410. Accordingly, as the rotation axis A shown in FIG. 17, the reflecting angle at the time of rotating horizontally with respect to the reflecting mirror 1410 becomes different from the reflecting angle at the time of rotating inclinedly at a predetermined angle with respect to the reflecting mirror 1410. In general, if the reflecting mirror 1410 precisely rotates on the horizontal axis A, the reflected light moves precisely vertically at the center of the axis A. If the reflecting mirror 1410 precisely rotates on the inclined axis, the reflected light precisely moves vertically at the center of the inclined axis in an inclined manner.

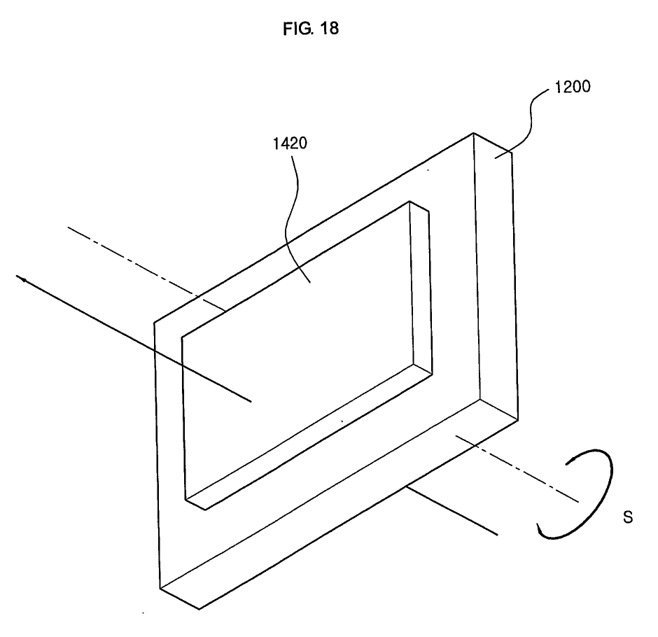

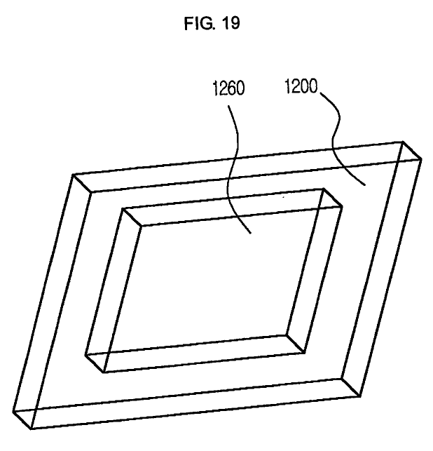

Referring to FIGS. 18 and 19, the refracting plate 1420 transmits the incident light in the direction indicated by the arrow in FIG. 18, and at this time, the refracting angle depends on the material, angle, etc. of the refracting plate 1420.

In addition, since the refracting plate 1420 precisely reciprocates and rotates with attachment to the precisely actuating member 1200 like the reflecting mirror 1410, the light path also changes according to the rotation direction of the precisely actuating member 1200.

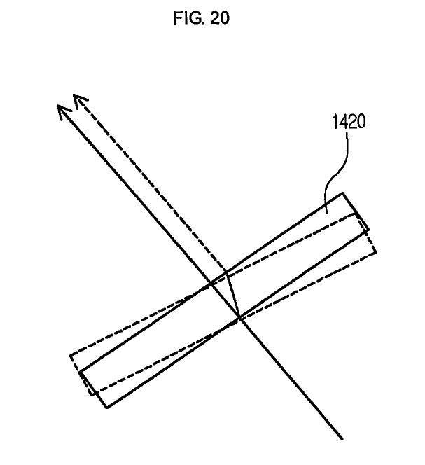

If the refracting plate 1420 is attached, since the refracting plate 1420 should transmit the light, the precisely actuating member 1200 to which the refracting plate attached preferably comprises a through hole 1260 on its center as shown in FIG. 20.

Referring to FIG. 20, the manner of operation of the refracting plate 1420 will be described.

To begin with, if a light is incident in the normal line direction of the refracting plate 1420, the light moves straight ahead, without being refracted, as indicated by the solid line shown in FIG. 20.

However, if the refracting plate 1420 is tilted at a predetermined angle, since the light is tilted with respect to the incident surface of the refracting plate 1420, the light moves straight after being refracted at a predetermined angle depending on the refractive index of the refracting plate 1420, whereby the light path changes as indicated by the dotted line in FIG. 20. In this manner, the refracting plate 1420 is attached to the precisely actuating member 1200 for precise rotation, whereby the light moves to a predetermined direction in a reciprocating manner.

Accordingly, if the image tilting device 1000 precisely rotates on the horizontal axis of rotation of the refracting plate 1420, the refracted light precisely moves vertically on the rotation axis. If the image tilting device 1000 precisely rotates on the inclined axis S, as shown in FIG. 18, the refracted light precisely moves vertically on the inclined axis (S) in a tilted manner.

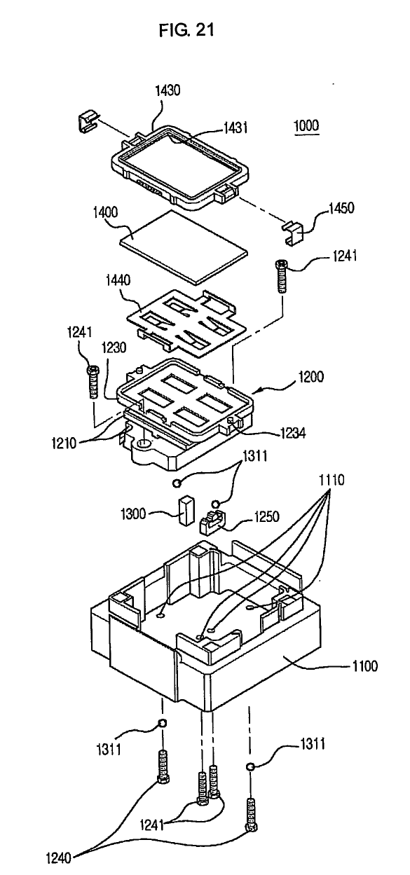

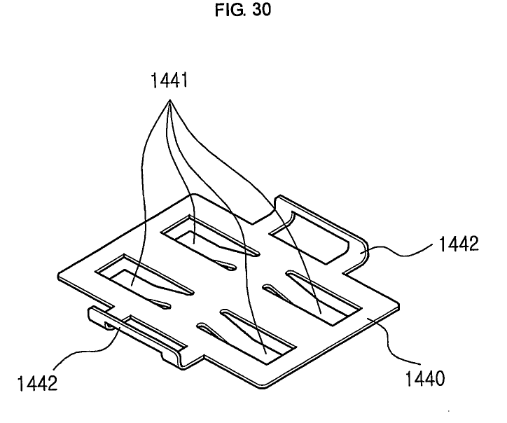

Hereinafter, referring to FIGS. 21 to 32, a variation of the image tilting device 1000 in accordance with another aspect of the present invention will be described in detail.

Referring to FIG. 21, the image tilting device 1000 comprises a casing 1100; a precisely actuating member 1200 which is housed within the casing 1100 and formed integrally so as to precisely rotate in a reciprocating manner; a driving member 1300 which contacts to the precisely actuating member 1200 to cause the precisely actuating member to drive; and a light path conversion member 1400 which is positioned above the precisely actuating member 1200 to convert the light path by the precise movement.

The image tilting device 1000 further comprises the precisely actuating member 1200, an adjustment screw 1240 for adjusting the initial angle of the support portion 1210 and the rotating portion 1230, a fastening screw 1241 for fastening the precisely actuating member 1200 on the casing 1100, a pre-pressure spring 1250 for adjusting the pre-pressure of the support portion 1210 and the rotating portion 1230, and a plurality of balls 1311 for point contact.

The image tilting device 1000 also comprises a protrusion portion 1431 at one side to support the light path conversion member 1400, and may comprise a frame 1430 of a predetermined height; and a supporting member 1440 which is covered on the other side of the protrusion portion 1431 of the frame 1430 to prevent the light path conversion member 1400 inserted into the frame 1430 from bending.

The frame 1430 of the light path conversion member 1400 and the precisely actuating member 1200 comprise a projection and a groove for assembly, respectively, and may further comprise a fastening spring 1450 for fixedly mounting the frame 1430 and the supporting member 1440 on the precisely actuating member 1200.

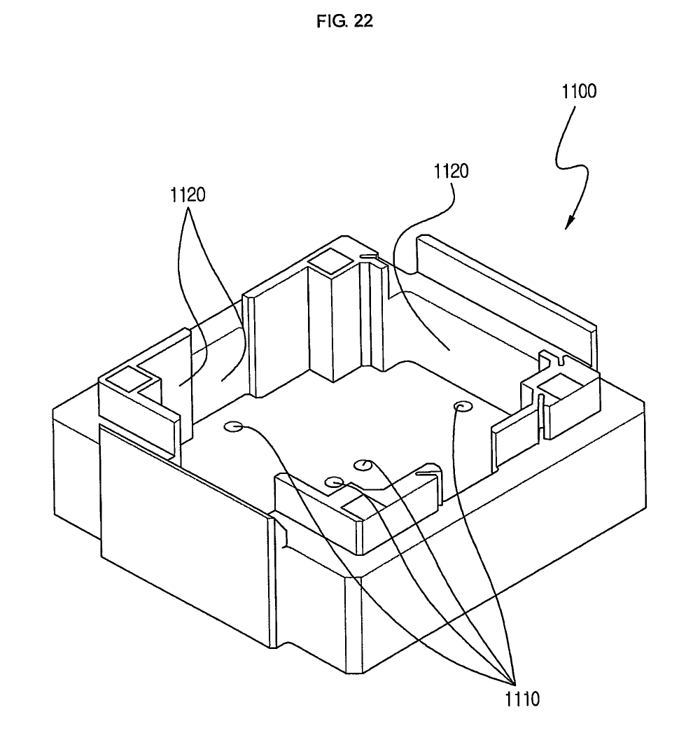

Referring to FIG. 22, the casing 1100 is of a rectangular parallelepiped shape having a predetermined space therewithin with its upper portion open. The bottom surface of the casing 1100 comprises a plurality of screw holes 1110 for fastening the precisely actuating member 1200, and the sidewalls of the casing 1100 comprise a plurality of vertical grooves 1120 corresponding to the shape of the precisely actuating member 1200.

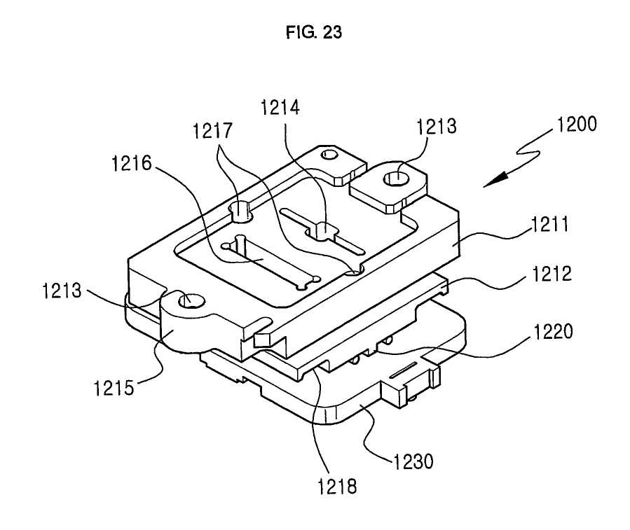

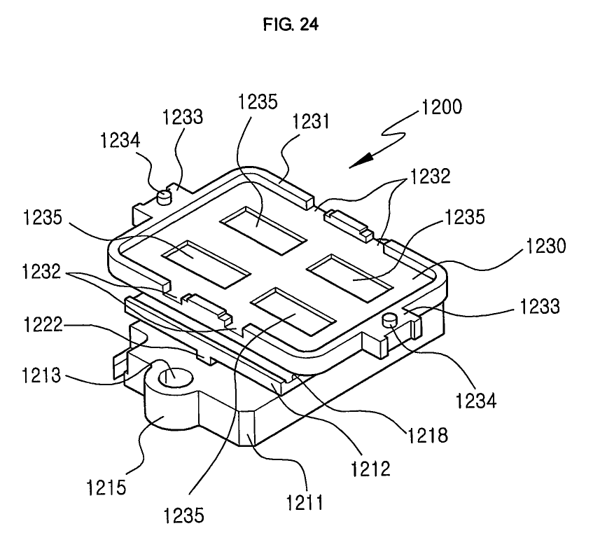

Referring to FIGS. 23 and 24, the precisely actuating member 1200 is composed of the first support portion 1211, the second support portion 1212, and the first hinge portion 1220, the second hinge portion 1222 and the rotating portion 1230.

The first support portion 1211 is of a plate shape, whose both ends are projected outward in a semi-circular shape, and the semi-circular projection 1215 comprises a first through hole 1213 for inserting a screw. The bottom surface of the first support portion 1211 bends inward to form a step, wherein the step comprises a second through hole 1214 and a third through hole 1216 of length direction in parallel with each other on its center. Fourth through holes to insert other screws are also disposed between both ends of the second and the thirds through holes 1214 and 1216.

The second support portion 1212 is connected by the second hinge portion 1222 to the first support portion 1211 to be disposed above the first hinge portion 1211, both ends of the second support portion 1222 having a groove 1218 formed at a regular width.

The rotating portion 1230 is connected to the second support portion 1212 by the first hinge portion 1220 to be disposed above the second support portion, each edge of the rotating portion 1230 extending vertically upward to form a rim 1231. The rim 1231 comprises a plurality of grooves 1232s on its opposite positions partially.

Both ends of the rotating portion 1230 have a rectangular extension 1233 which partially extends outward, the rectangular extension 1233 comprising a cylindrical projection 1234 projecting vertically upward.

The upper surface of the rotating portion 1230 further comprises a plurality of grooves 1235 of a rectangular shape, which are arranged in rows and columns.

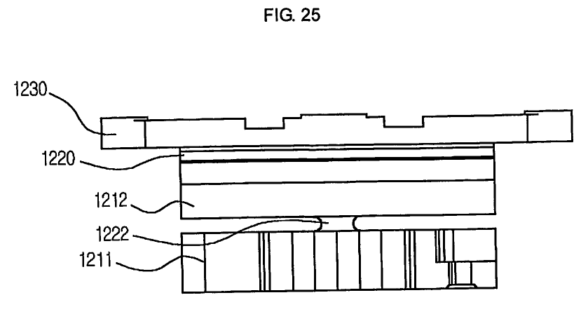

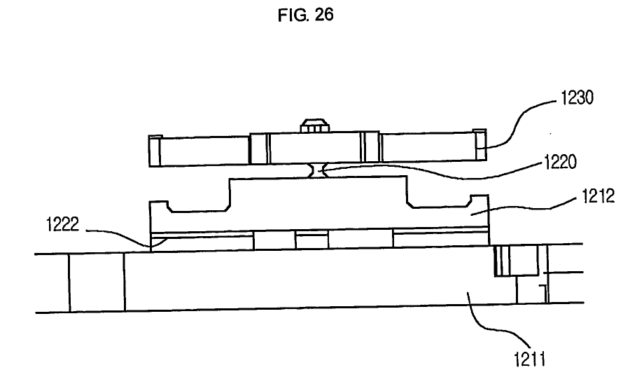

Referring to FIGS. 25 and 26, the first hinge portion 1220 supports the rotating portion 1230, which precisely rotates in reality, in the same manner as the plate spring, and the second hinge portion 1222 is to adjust the precise rotation of the second support portion 1212, the first hinge portion 1220 and the second hinge portion 1222 being perpendicular to each other in the length direction.

Since the rotation direction of the rotating portion 1230 and the second support portion 1212 is adjustable based on different axes, due to the perpendicular structure of the first hinge portion 1220 and the second hinge portion 1222, the rotation direction of the precisely actuating member is adjustable in a variety of manners.

Referring to FIG. 26, the second hinge portion 1222 is cut by a length equivalent to the width of the pre-pressure spring or the driving member in order to insert the pre-pressure spring or the driving member from the bottom of the first support portion 1211 or to be in contact with the second support portion 1212 or the rotating portion 1230. Since the pre-pressure spring or the driving member can be inserted through the first support portion 1211 due to this structure, the initial angle of the second support portion can be adjusted, and also transmit the movement of the driving member to the rotating portion 1230.

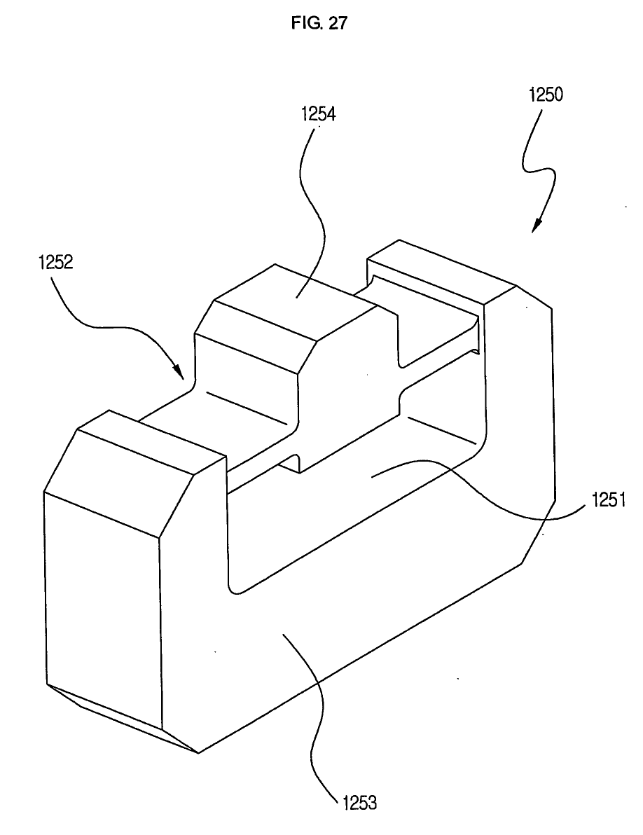

FIG. 27 illustrates the pre-pressure spring 1250, which is inserted into the precisely actuating member 1200 to adjust the pre-pressure.

The pre-pressure spring 1250 comprises a through hole 1251 in the middle of a plate shaped member having a predetermined thickness, which is divided into an elastic portion 1252 providing an elastic restoring force and a support portion 1253 supporting the elastic portion 1252. The elastic portion 1252 is of a narrower band than other portions, providing an elastic restoring force in the same manner as the plate spring.

The elastic portion 1252 comprises a projection 1254 extending vertically upward in the middle, wherein the projection 1254 is placed to be contactable with the bottom surface of the rotating portion 1230, and transmits the elastic restoring force of the pre-pressure spring 1250 when the rotating portion 1230 rotates precisely.

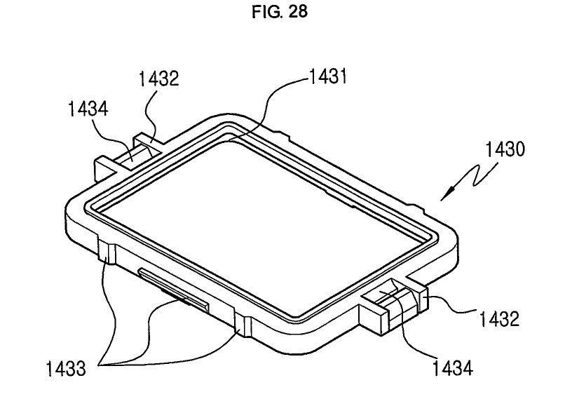

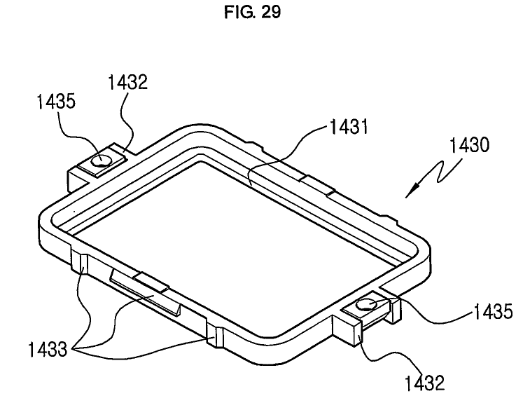

FIGS. 28 and 29 show the frame 1430 for supporting the light path conversion member 1400.

The upper surface of the frame 1430 is of a shape capable of covering and supporting the light path conversion member 1400, comprising a protrusion portion 1431 for locking the light path conversion member 1400 inside the frame 1230 so as not to being deviated.

The frame 1430 is provided with square projections 1432 for assembling with the precisely actuating member 1200 at both ends, and a plurality of connecting projections 1433 for attaching a support member, which will be explained later, at the other, both ends.

The square projection 1432 comprises a groove 1434 for attaching a fastening spring, which will be explained later, inside the upper surface to increase the assembly accuracy, and a groove 1435 of a shape corresponding to the cylindrical projection 1234 of the precisely actuating member 1200 for assembling with the precisely actuating member 1200, at the bottom surface.

The frame 1430 as described above is of a shape matching up with the rotating portion 1230 of the precisely actuating member 1200, which allows the light path conversion member 1400 to be securely attached on top of the rotating portion 1230 due to respective projections 1432, 1433 and grooves 1434, 1435 for assembly.

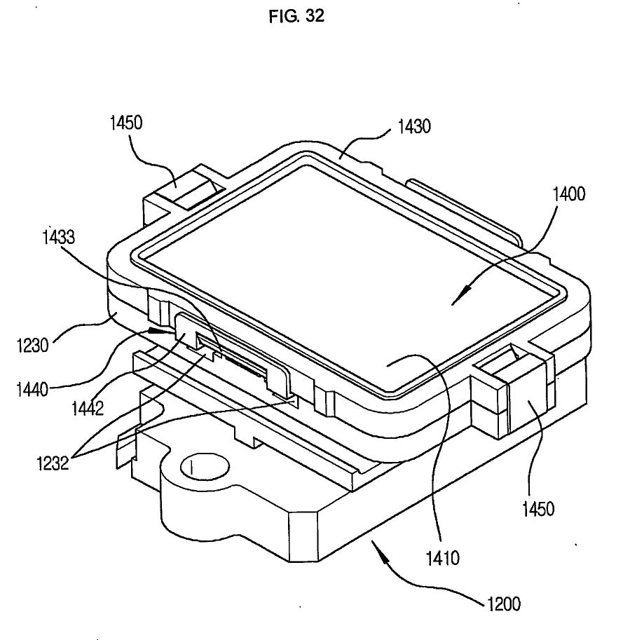

Referring to FIG. 32, there will be explained a supporting member 1440 which covers the other side of the protrusion portion 1431 of the frame 1430 to prevent the light path conversion member 1400 from bending.

The supporting member 1440 is attached to the bottom of the light path conversion member 1400 to support the light path conversion member 1400, having a predetermined plate shape capable of being locked tightly on the light path conversion member 1400. The plate-shaped portion comprises four legs 1441 which, after being assembled with the frame 1430, is safely reached to the rectangular groove 1235 formed at the rotating portion 1230 of the precisely actuating member 1200.

The legs 1441, after extending downward at a predetermined inclination at the plate-shaped portion, extend horizontally again so as to be horizontally secured into the rectangular groove 1235.

Both ends of the supporting member 1440 comprises a guide 1442 bent vertically upward which extends to the plate-shaped member so as to match with the binding projection 1433 provided on both ends of the frame 1430, which prevents the supporting member 1440 from being deviated by the elastic force.

The supporting member 1440 is configured such that the surface contact region of the light path conversion member 1400 with the supporting member 1440 is opposite to the surface contact region of the frame 1430 with the light path conversion member 1400, and that the bending moment applied to the light path conversion member 1400 becomes to minimize so that the line of action of the contact force can become in a straight line.

In addition, the surface where the supporting member 1440 and the frame 1430 contact with the light path conversion member 1400 is of a shape surrounding the outer perimeter of the light path conversion member 1400, which minimizes the stress concentration.

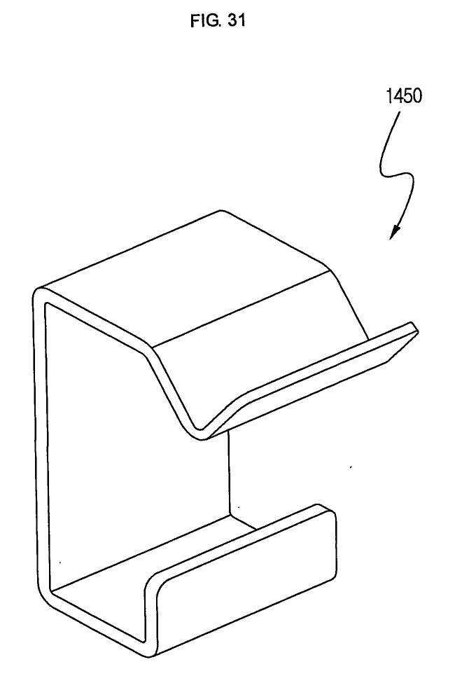

Referring to FIG. 31, there will be explained a fastening spring 1450 for securing fixedly the frame 1430 and the supporting member 1440 on top of the precisely actuating member 1200.

The fastening spring 1450 being a plate spring is of a shape vertically bent to make both ends horizontal, one end being then vertically bent inward again, and the other end being bent inward so as to have a predetermined inclination and thereafter being vertically bent with respect to the inclination.

The bent, both ends of the fastening spring 1450 can be widened and restored by the elastic force. The inward-bent structure of both ends is to secure the frame 1430 attaching the light path conversion member 1400 and the supporting member 1440 on the precisely actuating member 1200.

Referring to FIG. 32, there will be explained the assembly process of the precisely actuating member 1200 and the light path conversion member 1400.

First, the perimeter of the light path conversion member 1400 is covered by the frame 1430 to support the light path conversion member 1400, and then the supporting member 1440 is covered the frame 1400 from the bottom. The supporting member 1440 is locked to the binding projection 1433 of the frame 1430 by the guides 1442 provided with both ends, thereby supporting the light path conversion member 1400 securely.

The light path conversion member 1400 assembled with the frame 1430 and the supporting member 1440 as described above is placed on the rotating portion 1230 of the precisely actuating member 1200. At this time, since the rotating portion 1230 is configured such that the middle is closed, the light path conversion member applied to the variation of the image tilting device in accordance with another aspect of the present invention is preferably the reflecting mirror 1410.

The light path conversion member 1400 as assembled above is placed on the rotating portion 1230, and, at this time, the guide 1442 of the supporting member 1440 is locked to the groove 1232 which is partially formed at the perimeter of the rotating portion 1230, and is securely assembled with the matching structure provided with both ends of the frame 1430 and the rotating portion 1230. Thereafter, the fastening spring 1450 is fastened to both ends provided with the matching structure so that the precisely actuating member 1200 and the light path conversion member 1400 are fixedly secured in order not to break away from each other.

The precisely actuating member 1200 and the light path conversion member 1400 assembled as above insert the driving member 1300 and the pre-pressure spring 1250 from the bottom of the support portion 1210 as shown in FIG. 21.

The driving member 1300 and the pre-pressure spring 1250 also insert the ball 1311 into the portion where the precisely actuating member 1210 is inserted to contact the bottom surface of the rotating portion 1230, for the point contact with the precisely actuating member 1200. The ball 1311, which is additionally provided for the point contact, may form the shapes of the driving member 1300 and the pre-pressure spring 1250 into a circular shape.

The members assembled as above are housed within the casing 1100 to be secured to the screw hole 1110 of the casing 1100 by the fastening screw 1241.

The image tilting device 1000 in accordance with another aspect of the present invention assembled as described above comprises a plurality of adjustment screws 1240 which are inserted into the screw holes formed on the casing 1100, in order to adjust the initial angle of the support portion 1210 of the precisely actuating member 1200. A plurality of balls 1311 may be positioned on the adjustment screws 1240 for the point contact with the precisely actuating member 1200. The ball 1311 is additionally provided for the point contact, but may form the end shape of the adjustment screw into a sphere shape.

The projection system 2000 having the image tilting device 1000 in accordance with another aspect of the present invention will be described with reference to the accompanying drawings hereinbelow. The projection system 2000 in accordance with another aspect of the present invention may comprise the image tilting device 1000 in accordance with another aspect of the present invention.

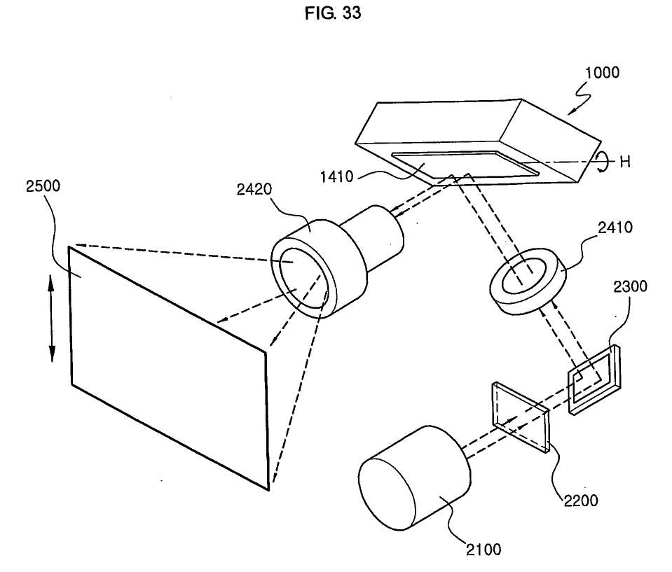

Referring to FIGS. 33 to 55, there will be explained the projection system 2000 in accordance with another alternative aspect of the present invention.

The projection system 2000 in accordance with another aspect of the present invention comprises a light source 2100 generating a white light; a color-processing device 2200 for imparting a predetermined color to the white light from the light source 2100; a micro display device 2300 which displays a predetermined image by using the light processed by the color-processing device 2200; at least one projection lens 2400 which projects an image displayed on the micro display device 2300; an image tilting device 1000 which receives an image of the projection lens 2400 and precisely rotates the image at a predetermined angle, and converts the path thereof to be transmitted; and a screen 2500 which magnifies the image which is precisely rotated by the image tilting device 1000.

A lamp light source generating a white light may be used as the light source 2100.

The color-processing device 2200 is a color filter for separating the white light of the light source into red, green, and blue falling under trichromatic colors, which arranges filters for respective colors adjacently to respectively and applies a signal corresponding to respective colors to control the illumination, thereby expressing various colors.

The micro display device 2300 is to display an image on the micro panel by using the color displayed by the color-processing device 2200. A reflective, micro display is used in the projection system in accordance with another alternative aspect of the present invention.

The projection lens 2400 may comprise a first projection lens 2410, which projects an image displayed by the micro display device 2300 for adjusting an angle, and a second projection lens 2420, which magnifies and displays an image of which the angle is adjusted.

The image tilting device 1000, which receives an image of the projection lens 2410, rotates precisely the image at a predetermined angle, and converts the path of the image for transmission, may use a reflective mirror 1410, a refractive plate 1420, etc. to convert the path of image. The projection system 2000 in accordance with another alternative aspect of the present invention preferably comprises the image tilting device 1000 in accordance with another aspect of the present invention.

The image tilting device 1000 may precisely rotates so that an image displayed on the screen through the light path conversion member 1400 can move to the diagonal axis direction of the screen 2500 in a reciprocating manner.

The image tilting device 1000 may also precisely rotates on the diagonal axis of the light path conversion member 1400.

FIG. 33 illustrates a first embodiment of the projection system in accordance with another alternative aspect of the present invention.

In the projection system 2000 as shown in FIG. 33, the white light generated from the light source 2100 has a light synchronized with the image displayed on the micro display device 2300 as passing through the color-processing device 2200. The image displayed on the micro display device 2300, after passing through the first projection lens 2410, is reflected by the image tilting device 1000, to which the reflective mirror 1410 is attached, to be then magnified on the screen 2500 by the second projection lens 2420.

The reflective mirror 1410 is attached to the image tilting device 1000 to rotate by the rotation of the image tilting device 1000. At this time, since the image tilting device 1000 may rotate on the longitudinal or horizontal axis thereof, or may rotate on the oblique axis of a predetermined angle, the rotation direction of the reflective mirror 1410 attached thereto changes together.

As illustrated in FIG. 33, an image which rotates on the horizontal rotation axis H of the image tilting device 1000 moves precisely up and down the screen 2500 in the same direction as indicated by the arrow on the screen 2500.

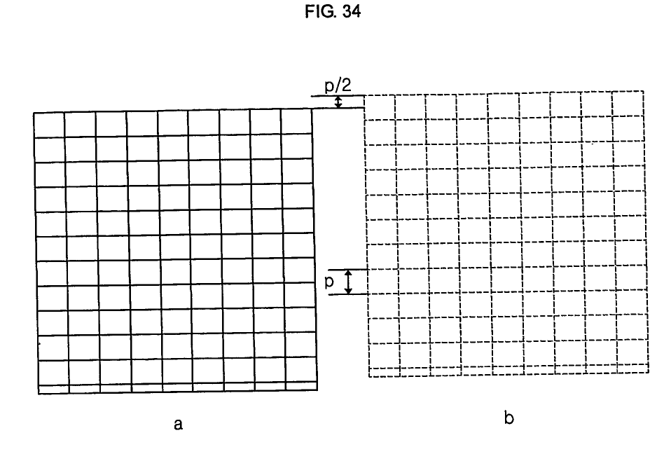

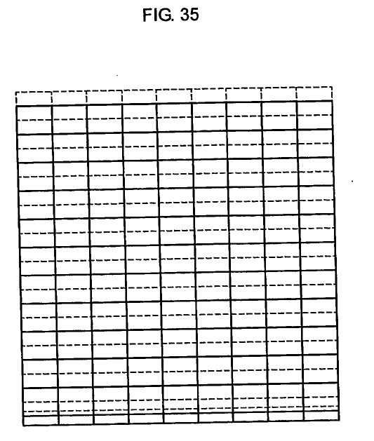

Referring to FIGS. 34 and 35, the principle of the increase of resolution when the image moves precisely up and down the screen 2500 as described above will be explained.

When the image tilting device 1000 is at the initial position, the pixels of the image projected on the screen 2500 are shown in FIG. 34-a. If the image tilting device 1000 rotates at a precise angle, the pixels of the image projected on the screen 2500 move precisely on the screen 2500 overall to become an image like FIG. 34-b. If the images of such two states are periodically displayed on the screen 2500 at less than 0.03 second intervals, that is, if the image tilting device 1000 does regular periodic motion at a high speed, the human eye recognizes a combination image of FIG. 35 that the image of FIG. 34-a and that of 34-b are overlapped.

In this case, if the length of the movement of the images by the image tilting device 1000 is p/2 which is half the vertical height p of the original pixel size, the image of FIG. 34-a and the image of FIG. 34-b overlap by a half pixel, the human eye recognizes the pixels of FIG. 35 which got smaller by a half, whereby the visible resolution increases.

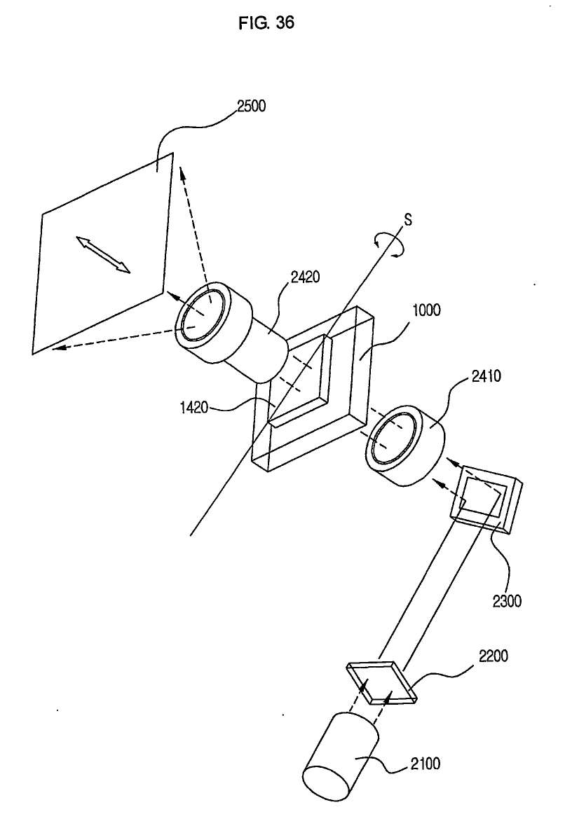

FIG. 36 illustrates a second embodiment of the projection system 2000 in accordance with another alternative aspect of the present invention.

In the projection system 2000 as shown, the white light generated from the light source 2100 has a light of the color synchronized with the image displayed on the micro display device 2300 as it passes through the color-processing device 2200. The image displayed on the micro display device 2300, after passing through the first projection lens 2410, is refracted and transmitted at a predetermined angle by the image tilting device 1000, to which the refraction plate 1420 is attached, to be then magnified on the screen 2500 by the second projection lens 2420.

The refraction plate 1420 is attached to the image tilting device 1000 to be rotated by the rotational movement of the image tilting device 1000. At this time, since the image tilting device 1000 may rotate on the vertical or horizontal axis of the image tilting device 1000, or may rotate on the oblique axis (S) of a predetermined angle, the rotation direction of the refractive plate 1420 attached thereto changes accordingly.

The image which rotates on the oblique axis (S) of the image tilting device, as shown in FIG. 36, moves precisely in the oblique direction of the screen 2500, which is the same direction as indicated by the arrow on the screen 2500.

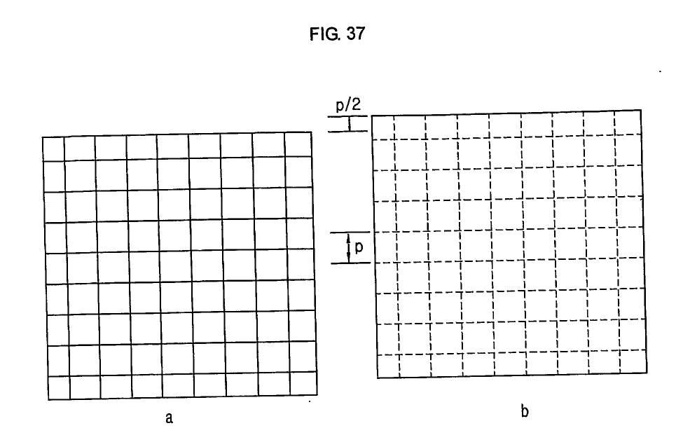

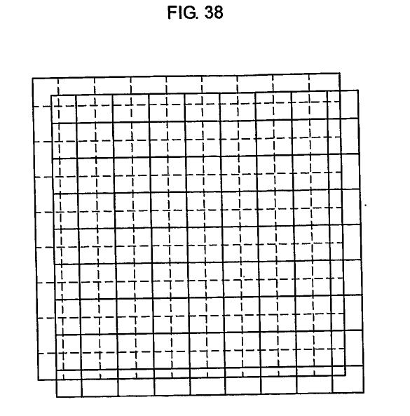

In FIGS. 37 and 38, there will be explained the principle of the increase of resolution when the image moves precisely in the oblique direction of the screen 2500, as described above.

When the image tilting device 1000 is at the initial position, the pixels of the image projected on the screen 2500 are shown in FIG. 37-a. When the image tilting device 1000 rotates at a precise angle, the pixels of the image projected on the screen 2500 overall move precisely on the screen 2500 to become an image like FIG. 37-b. If the images of such two states are periodically displayed on the screen 2500 at less than 0.03 second intervals, that is, if the image tilting device 1000 does regular periodic motion at a high speed, the human eye recognizes a combination image of FIG. 38 that FIGS. 37-a and 37-b are seen overlapping.

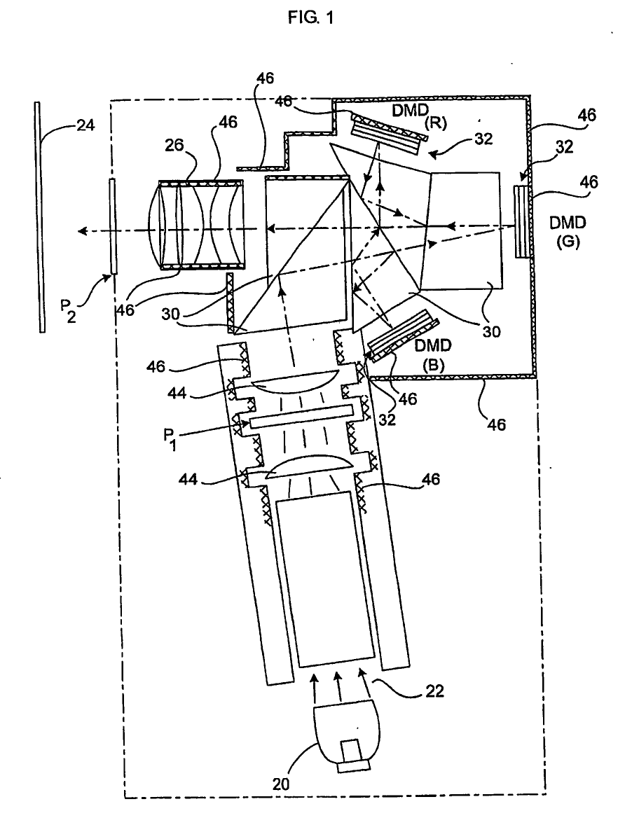

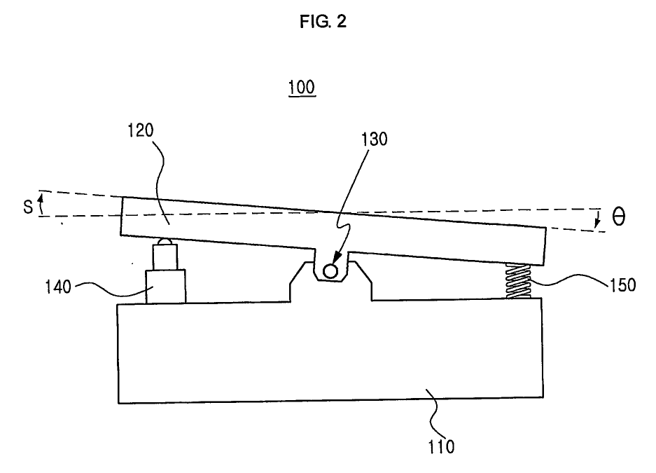

That is, if the image tilting device 1000 moves precisely like the image of FIG. 37-b which moves vertically or horizontally by a half pixel p/2 with respect to the image of FIG. 37-1, the human eye recognizes the image which became smaller by a quarter like FIG. 38, whereby the visible resolution increases four times.

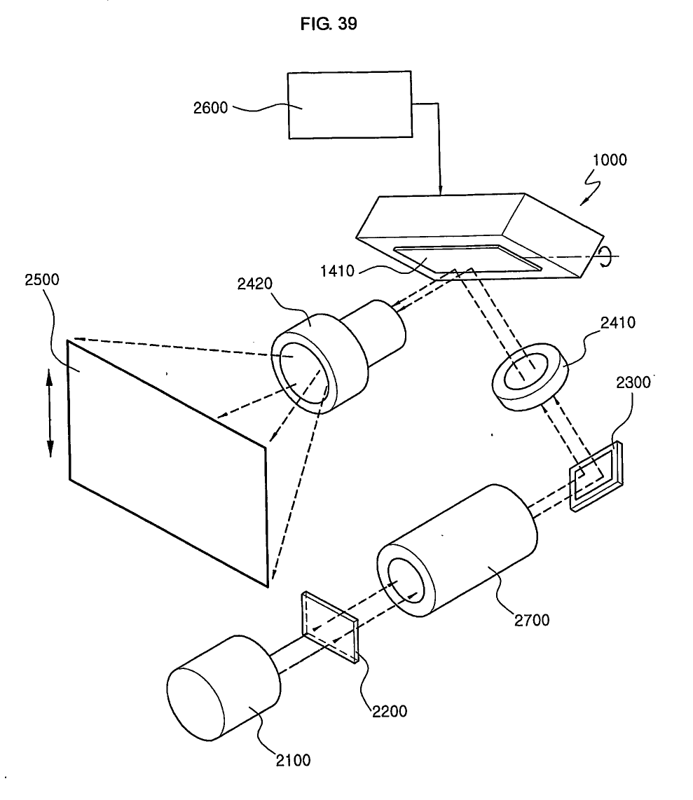

FIG. 39 illustrates a third embodiment of the projection system in accordance with another alternative aspect of the present invention.

The projection system 2000 comprises a light source 2100 generating a white light; a color-processing device 2200 for imparting a predetermined color to the white light from the light source 2100; a micro display device 2300 which displays a predetermined image by using the light processed by the color-processing device 2200; at least one projection lens 2400 which projects an image displayed on the micro display device 2300; an image tilting device 1000 which receives an image of the projection lens 2400 and rotates precisely the image at a predetermined angle, and converts the path of the image to transmit; and a screen 2500 which magnifies the image which is precisely rotated by the image tilting device 1000.

The projection system 2000 further comprises a control-wave generating device 2600, which generates a control-wave for driving the image tilting device 1000.

The projection system 2000 may further comprise an optical device 2700 for imaging the light processed by the color-processing device 2200.

The optical device 2700 concentrates the light on the micro display device 2300 in such a form that the light can be effectively incident on the micro display device 2300.

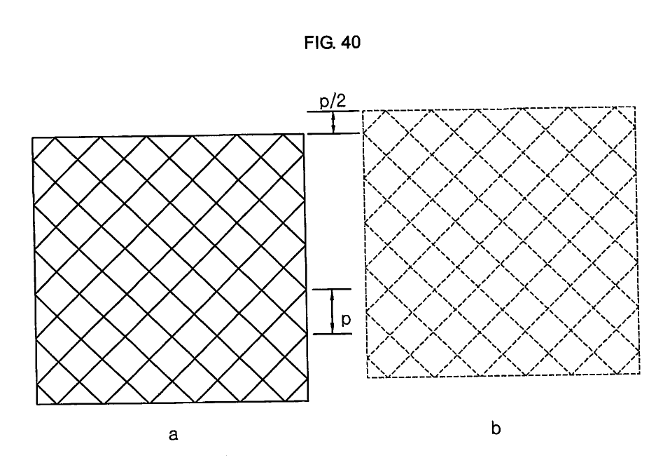

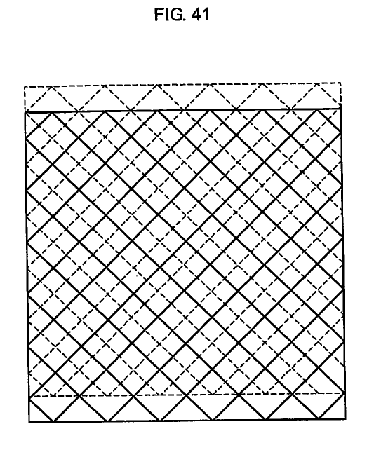

In the projection system 2000, the micro display device 2300 may be arranged so that the pixel is obliquely illuminated on the screen 2500, which will be explained later with reference to FIGS. 40 and 41.

The micro display device 2300 is arranged such that the pixel is placed in the oblique direction as shown in FIG. 40-a. Accordingly, when the image tilting device 1000 is at the initial position, the image projected on the screen 2500 is shown as the FIG. 40-a. When the image tilting device 1000 rotates at a precise angle, the image projected on the screen 2500 overall moves precisely on the screen 2500 to become an image like FIG. 40-b. If the images of such two states are periodically and repeatedly displayed on the screen 2500 at less than 0.03 second intervals, that is, if the image tilting device 1000 moves at a high speed in a regular periodic manner, the human eye recognizes a combination image of FIG. 41 which FIGS. 40-a and 40-b are seen overlapping.

In this case, if the movement of the images by the image tilting device 1000 is, for example, p/2 which is half the diagonal height p of the original pixel size, the image of FIG. 40-a and the image of FIG. 40-b overlap by a half pixel above and below. At this time, the variation of the actual height is merely a half the original pixel size, but the human eye recognizes the pixels of FIG. 41, which gets smaller to a quarter of its original size since the pixel of the micro display device 2300 is arranged in the diagonal direction. Thus, the visible resolution increases four times.

The projection system 2000 in accordance with another alternative aspect of the present invention further comprises a control-wave generating device 2600, which generates a control wave for controlling the movement of the image tilting device 1000.

The control-wave generating device 2600 generates a control wave having two values for periodically reciprocating the image tilting device 1000 during a regular time period between two predetermined angular positions.

The control-wave generating device 2600 generates a resultant wave of such a shape that the horizontal, flat portion of a square wave is linked with the rising portion or the falling portion of the sine wave, in order to reduce the residual oscillation of the control-wave signal.

The flat portion of the resultant wave is composed of the upper flat portion and the bottom flat portion, each flat portion having at least one step.

The at least one step is configured such that the upper flat portion is symmetrical to the bottom flat portion.

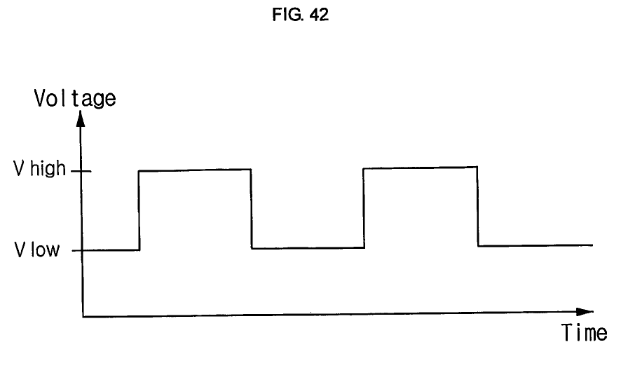

Referring to FIGS. 42 to 55, there is explained the control-wave generating device 2600 applied to the projection system in accordance with another alternative aspect of the present invention.

In order to position periodically the image tilting device 1000 at the two predetermined angular positions during a regular time period, the control-wave generating device 2600, as shown in FIG. 42, generates a square wave control signal defined by two predetermined voltages (V_{high}, V_{low}). Accordingly, the image tilting device 1000 does an angular movement following the square wave control signal.

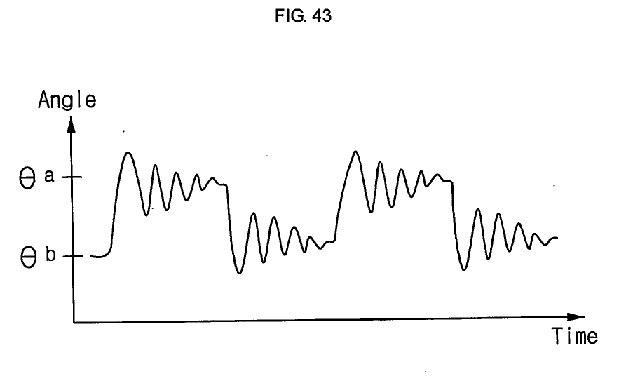

FIG. 43 is a graph illustrating the rotation angle of the image tilting device 1000, which does the angular movement following the square wave control signal. As shown in FIG. 43, if the square wave control signal is applied to the image tilting device 1000, the angular movement does a feature having a residual oscillation. The residual oscillation is generated by a rapid control input, i.e., impulsive force, due to a rapidly changing portion of the square wave control signal.

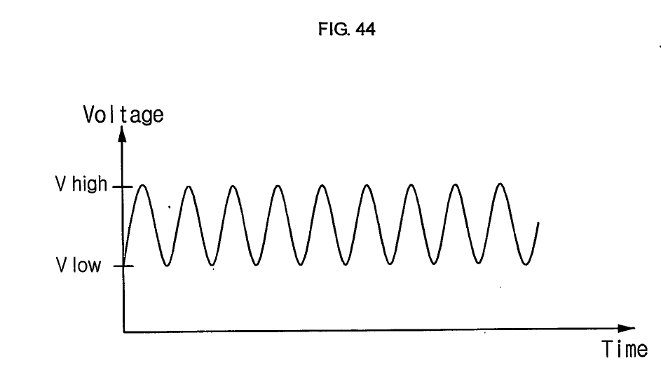

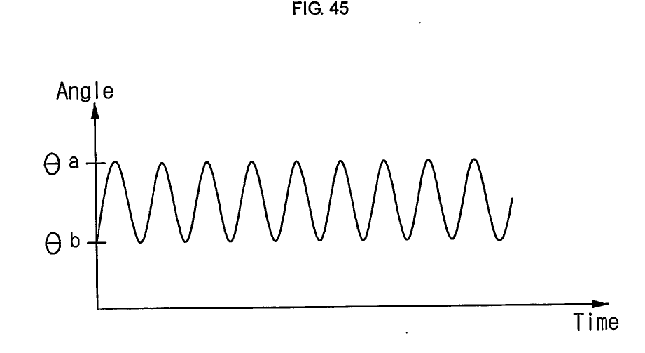

As shown in FIG. 44, when the sine wave-shaped control signal defined by the two predetermined voltages (V_{high}, V_{low}) is applied to the image tilting device 1000 in order to reduce the residual oscillation due to the square wave input signal as described above, the image tilting device 1000 exhibits a sine wave-shaped angular movement following the sine wave driving signal, as shown in FIG. 45. Accordingly, the image tilting device 1000 in accordance with another aspect of the present invention exhibits the feature of following the sine wave.

The following movement happens when the frequency of the sine wave control signal is less than the natural frequency of the image tilting device 1000, which is the case for all mechanical driving systems.

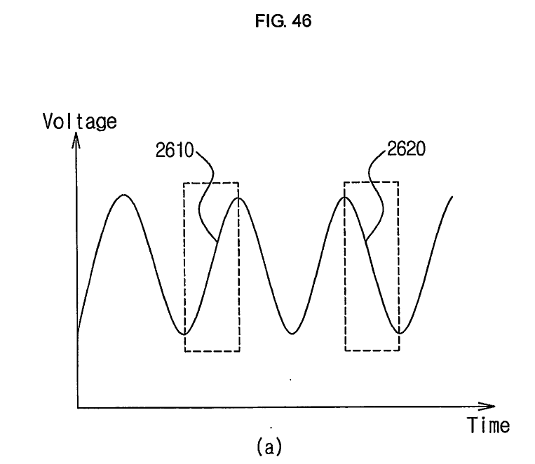

Referring to FIGS. 46 to 49, in order to use the characteristic of following sine wave in a periodical rotation movement having two angular states, the principle of generating a control wave of the control-wave generating device 2600 will be explained.

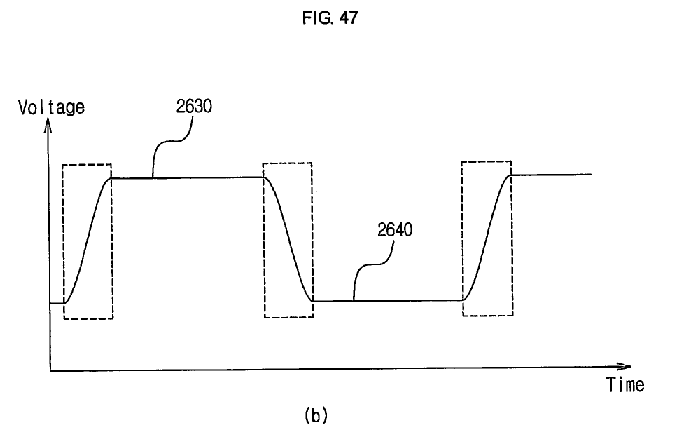

Referring to FIGS. 46 and 47, in order to regularly position the rotation angles of the image tilting device 1000 at the two angle positions, the curve portion corresponding to the rising portion 2610 or the falling portion 2620 of the sine wave is positioned between the two flat portions of the square wave having the two flat portions 2630 and 2640.

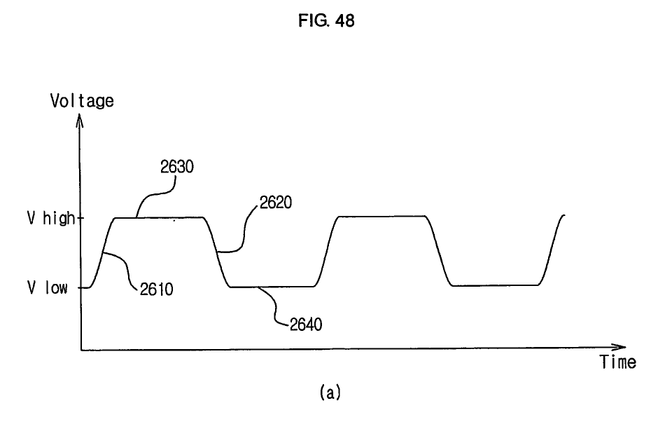

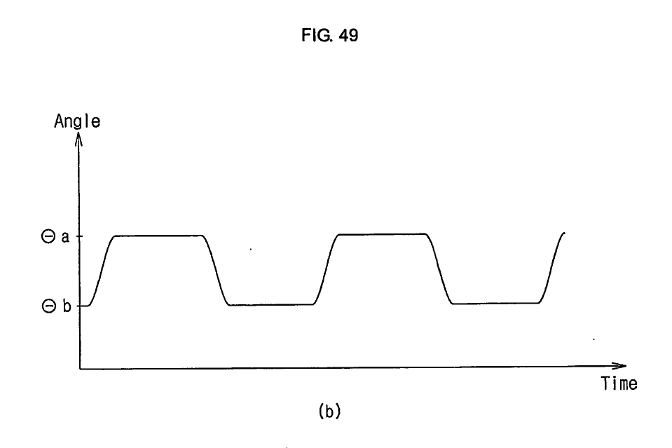

FIGS. 48 and 49 show the control wave when the image tilting device 1000 is actuated by the control signal, and the angle output of the image tilting device 1000.

The control wave has two flat portions 2630 and 2640, but can reduce significantly the residual oscillation of the image tilting device 1000 generated when actuated only by the square wave, by substituting the rapidly changing portion of the square wave, where the two values change rapidly, with the rising portion 2610 or the falling portion 2620 of the sine wave. Accordingly, the image tilting device 1000 also follows the sine wave to precisely rotate in a reciprocating manner so as to have a predetermined angular variation value as shown in FIG. 49.

When the projection system 2000 in accordance with another alternative aspect of the present invention is driven by actuating the image tilting device 1000 by the control-wave generating device, the image displayed on the screen 2500 is seen as an image having an increased visible resolution due to the optical illusion of the human eye as shown in FIG. 38 or 41.

However, when people watch the image having an increased visible resolution, if the direction of glance changes swiftly, or if the human eye blinks or a sudden change happens such as a rapid change of the image displayed, a phenomenon like a camera shutter occurs to the human eye function. Thus, one of the two original images forming the increased visible resolution image in FIG. 38 or 41 is directly seen. In other words, the optical illusion disappears, an image of low resolution comes in sight, and the pixel grid is seen.

The control-wave generating device 2600 applied to the projection system in accordance with another alternative aspect of the present invention generates a control wave having at least one step in order to reduce the resolution degradation.

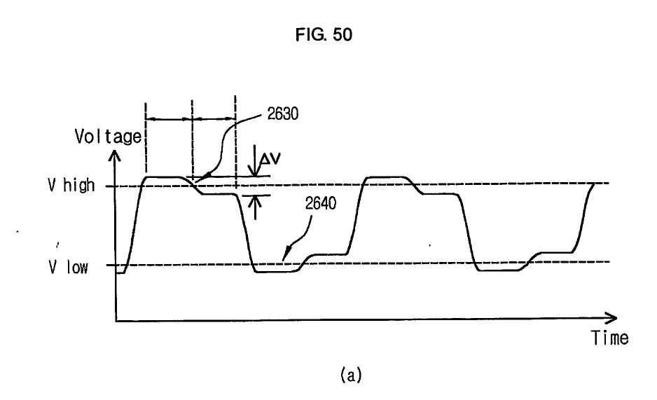

Referring to FIGS. 50 to 55, the control wave has two flat portions having a same voltage displacement (Δv/2) above and below the original voltage (V_{high}). The two flat portions are maintained for the same time period, respectively, which are linked by the sine wave as shown in FIG. 48. The bottom flat portion 2640 has two different, flat portions like the upper flat portion 2630, which are symmetrical to each other at the upper flat portion 2630 and the bottom flat portion 2640.

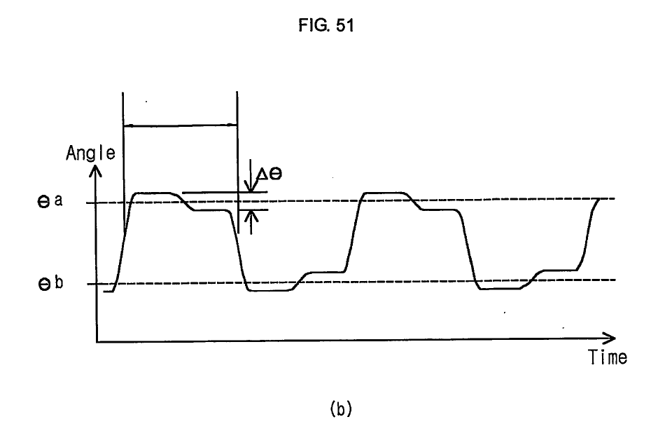

Due to the control wave as described above, the image tilting device 1000, as shown in FIG. 51, rotates precisely in a reciprocating manner at an angular displacement modulated by Δθ/2.

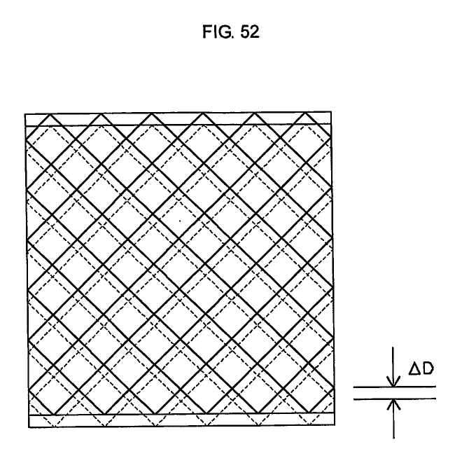

Accordingly, due to the modulated angular displacement, the image displayed on the screen 3500 during the time period when the image tilting device 1000 has the displacement of Δθ at the flat portions 2630 and 2640, has the displacement ΔD corresponding to Δθ as shown in FIG. 52.

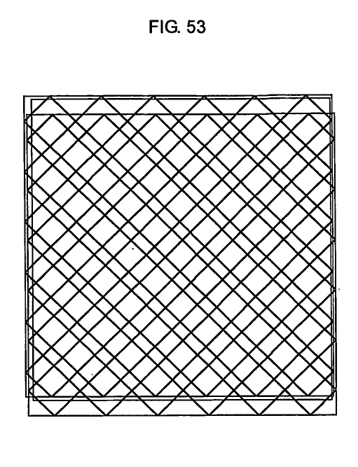

That is, since due to the step of the upper flat portion 2630 of the modulated angular displacement, the images corresponding to each step is seen overlapping, whereby the grid looks blurry due to the average perception of the human eye, as shown in FIG. 53. Accordingly, it is perceived that the image quality is good, since the grid is less emphasized.

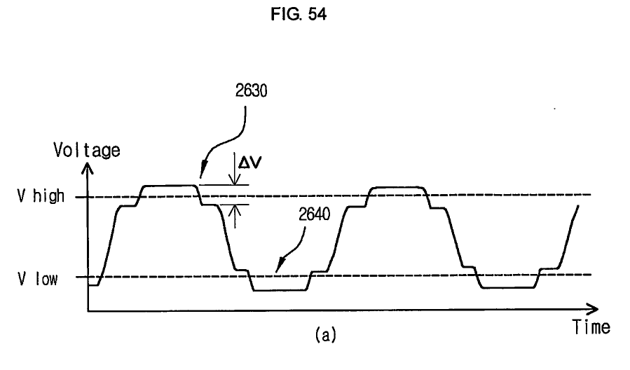

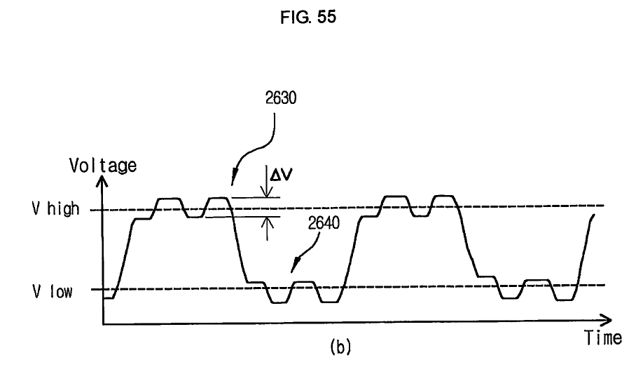

FIG. 54 shows a modulated control wave having three steps at respective flat portions 2630 and 2640, and FIG. 55 shows a modulated control wave having four steps at respective flat portions 2630 and 2640.

Each step has the same voltage displacement (Δv/2) high and low the original voltages (V_{high}, V_{low}), and is maintained during the same time period, respectively.

The precisely actuating member and the image tilting device in accordance with a preferred aspect of the present invention, and the operation and effects of the projection system will be explained hereinbelow.

The precisely actuating member in accordance with one aspect of the present invention comprises a predetermined plate-shaped support portion, which is integrated by a material having an elastic restoring force, a predetermined plate-shaped rotating portion which disposed on the support portion, and a hinge portion of bottleneck structure which connects the support portion and the rotating portion and acts as a plate spring.

If any external force is applied to the rotating portion, the rotation portion precisely rotates periodically on the axis of the hinge portion due to its elasticity until it is returned to its original position. At this time, a mirror attached on the upper surface of the rotating portion also rotates precisely, whereby a light or an image reflected on the mirror can rotate precisely.

Since the precisely actuating member is integrated, unnecessary recesses are reduced relative to a precisely actuating member which is assembled with a plurality of members, and the rotation accuracy also increases since it rotates precisely only by the elastic restoring force of the material itself.

The image tilting device in accordance with another aspect of the present invention houses the precisely actuating member integrated within the casing, and the driving member, which contacts to the precisely actuating member to cause the movement of the precisely actuating member.

The precisely actuating member is composed of a plurality of support portions, rotating portion, and a plurality of hinge portions, wherein a piezoelectric driving element or an electromagnetic driving element is arranged between the support portion and the rotating portion. The length of the driving elements changes if voltage is applied, and such mechanical motion is transmitted to the rotating portion of the precisely actuating member which contacts with the driving elements. Accordingly, the rotating portion moves precisely.

At this time, since the hinge portion integrated between the support portions elastically supports the rotating portion, the rotating portion precisely rotates on the axis of the hinge in a reciprocating manner. The precisely actuating member can precisely rotate without loss of the driving force, since it is integrated with the support portions, rotating portion, and hinge portions. In addition, the light path conversion member attached to the upper surface of the rotating portion reciprocates and rotates according to the movement of the rotating portion.

The projection system in accordance with another alternative aspect of the present invention comprises a light source generating a white light; a color-processing device for imparting a predetermined color to the white light from the light source; a micro display device for displaying a predetermined images by use of the light processed by the color-processing device; at least one projection lens for projecting the images displayed on the micro display device; an image tilting device for receiving and rotating precisely the images of the projection lens at a predetermined angle to convert the path for transfer; and a screen for magnifying to display the images rotated precisely by the image tilting device. The preferred image tilting device uses the image tilting device in accordance with another aspect of the present invention.

The projection system comprising the image tilting device in accordance with another aspect as described above transmits the image passing through the light source, the color-processing device, the micro display device, and the projection lens to the image tilting device.

Since the image tilting device reciprocates and rotates minutely if voltage is applied, the image transmitted to the image tilting device also precisely moves obliquely to a predetermined direction by the light path conversion member attached to the image tilting device.

At this time, the projection system in accordance with another alternative aspect of the present invention may make the image reciprocate in the diagonal direction of the screen by positioning the pixel of the micro display device obliquely with respect to the projection surface of the screen. In addition, the image tilting device itself reciprocates and rotates in the oblique direction of the screen, thereby allowing the image to precisely move obliquely to the projection surface of the screen.

If the image precisely reciprocates and rotates obliquely as described above, the displacement occurs up and down the pixel due to the oblique movement direction, so that the upper and lower sides of the pixel look overlapping. Accordingly, the boundary with respect to every sides of the pixel becomes blurry. As a result, the resolution increases due to the optical illusion.

The projection system in accordance with another alternative aspect of the present invention further comprises a control-wave generating device, thereby increasing the visible resolution.

In general, when an image of increased visible resolution is seen by an optical illusion, if eyesight changes rapidly, a phenomenon as if pressing a camera shutter takes place, whereby the image looks as if it is still. Then, the pixel grid of the screen is visually perceived directly, so the resolution looks degraded.

To resolve this problem, the control-wave generating device generates a modulation control wave having a predetermined step at the flat portion of the control wave to precisely and rotates the precisely actuating member so as to following the modulation control wave. Then, the images, which moved by the displacement corresponding to the value of each step, look overlapping, whereby the image quality is perceived as good since the grid of the pixel is less emphasized.

Hereinabove, the image tilting device in accordance with another aspect of the present invention, and the projection system having it were explained. However, the image tilting device may be applied to light scanning systems, etc. which are actuated to form patterns on a semiconductor wafer, in addition to the projection system by using the principle of the precisely reciprocating rotation of the driving member or the control-wave generating device.

Since the precisely actuating member in accordance with one aspect of the present invention can rotate precisely by the elastic force without unnecessary movement since it is integrated, it can precisely rotate an image.

Since the image tilting device in accordance with another aspect of the present invention comprises an integrated precisely actuating member, thereby minimizing unwanted movements and rotating precisely an image without loss of the driving force.

In addition, the projection system in accordance with another alternative aspect of the present invention can reduce the volume of the system itself by using the image tilting device in accordance with another aspect of the present invention, and can increase the image quality even with the existing display panel in use by adjusting freely the rotation angle of the image tilting device rotating precisely.

While this invention has been shown and described with references to preferred aspects thereof, it will be understood by those skilled in the art that various changes in form and details may be made therein without departing from the scope of the invention encompassed by the appended claims.

1. A precisely actuating member comprising:
a predetermined plate-shaped support portion;
a hinge portion of bottleneck structure extending vertically upward, which is integrated with said support portion, and runs from one end to the other end of said support portion; and
a rotating portion, which is integrated with said support portion and said hinge portion, is connected by said hinge portion to be disposed on said support portion, and reciprocates and rotates precisely right and left on the axis of said hinge portion.

2. The precisely actuating member according to claim 1, wherein a mirror is attached to said rotating portion.

3. An image tilting device comprising:
a casing;
a precisely actuating means which is housed within said casing and is integrated therewith so as to precisely reciprocate;
a driving means which contacts to said precisely actuating member for the movement thereof; and
a light path conversion means, which is placed on said precisely actuating means to be able to convert a light path by a precise movement.

4. The image tilting device according to claim 3, wherein said precisely actuating means comprises:
a predetermined plate-shaped support portion;
a first hinge portion of bottleneck structure extending vertically upward, which runs from one end to the other end of said support portion; and
a rotating portion, which is connected by said first hinge portion to be disposed on said support portion, and precisely reciprocates and rotates right and left on the axis of said first hinge portion.

5. The image tilting device according to claim 4, wherein said support portion is plural.

6. The image tilting device according to claim 5, wherein said plurality of support portion is connected up and down a second hinge portion of bottleneck structure extending vertically upward which runs from one end to the other end of said support portion.

7. The image tilting device according to claim 6, wherein said second hinge portion is perpendicular to said first hinge portion.

8. The image tilting device according to claim 4, wherein said precisely actuating means further comprises an adjustment screw for adjusting the initial angle of the support portion and the rotating portion.

9. The image tilting device according to claim 4, wherein said precisely actuating means further comprises a pre-pressure spring for adjusting the pre-pressure of said support portion and said rotating portion.

10. The image tilting device according to claim 4, wherein said driving means precisely rotates the rotating portion by contacting with the rotating portion of the precisely actuating member.

11. The image tilting device according to claim 10, wherein said driving means is a piezoelectric driving element which converts an electric energy into a mechanical energy to drive said precisely actuating member.

12. The image tilting device according to claim 11, wherein said piezoelectric driving element point contacts with said precisely actuating member.

13. The image tilting device according to claim 12, wherein said precisely actuating means further comprises a plurality of balls for point contacts.

14. The image tilting device according to claim 10, wherein said driving means is an electromagnetic driving element which generates a mechanical energy by a variation of magnetic field to precisely rotate said precisely actuating member.

15. The image tilting device according to claim 14, wherein said electromagnetic driving element comprises:
a yoke, which has a predetermined shape for easily generating an electromagnetic force and being attachable to said precisely actuating member;
a permanent magnet for forming a magnetic field by attachment to said yoke; and
an electric wire, which is disposed between said yoke and said permanent magnet so as to form a magnetic field with said permanent field.

16. The image tilting device according to claim 15, wherein said predetermined shaped yoke has a plurality of branches disposed in parallel.

17. The image tilting device according to claim 15, wherein said electric wire is a coil wound around the branches of said yoke.

18. The image tilting device according to claim 15, wherein said precisely actuating means comprises at least one connection, which contacts with said electromagnetic driving element, in order to transmit a mechanical energy of said electromagnetic driving element to said precisely actuating member.

19. The image tilting device according to claim 15, wherein said electromagnetic driving element is disposed at both ends of said precisely actuating means.

20. The image tilting device according to claim 4, wherein said support portion, said hinge portion, and said rotating portion are made of a material having an elastic restoring force.

21. The image tilting device according to claim 20, wherein said material is aluminum.

22. The image tilting device according to claim 20, wherein said material is plastic.

23. The image tilting device according to claim 3, wherein said light path conversion means is a reflective mirror.

24. The image tilting device according to claim 3, wherein said light path conversion means is a refractive plate.

25. The image tilting device according to any one of claim 23, wherein said image tilting device further comprises:
a frame of a predetermined height which comprises a protrusion portion at one side for supporting said light path conversion member; and
a supporting member, which is covered at the other side of said protrusion portion of said frame to prevent said light path conversion member from bending.

26. The image tilting device according to claim 25, wherein said frame of said light path conversion member and said precisely actuating member respectively comprise a projection and a groove for assembly.

27. The image tilting device according to claim 26, wherein the image tilting device further comprises: a frame of said light path conversion means and a fastening spring for fixedly mounting the support member above the precisely actuating means.

28. A projection system comprising:
a light source, which generates a white light;
a color-processing means for imparting a predetermined color to the white light from said light source;
a micro display means, which can display a predetermined image by using the light processed by said color-processing means;
at least one projection lens which projects an image displayed on said micro display means;
an image tilt means which precisely rotates the image inputted from said projection lens to then convert the path of the image to be transmitted; and
a screen, which magnifies and displays the image being rotated by said image tilt means.

29. The projection system according to claim 28, wherein said projection system further comprises an optical means for imaging the light processed by said color-processing means.

30. The projection system according to claim 29, wherein said micro display means is disposed so that a pixel is reflected obliquely on said screen.

31. The projection system according to claim 29, wherein said image tilt means precisely rotates so that the image reflected on said screen through said light path conversion means moves toward the direction of the diagonal axis of said screen in a reciprocating manner.

32. The projection system according to claim 31, wherein said image tilt means precisely rotates on the diagonal axis of said light path conversion means.

33. The projection system according to claim 28, wherein said image tilt means comprises:
a casing;
a precisely actuating means which is housed within said casing and is integrated so as to precisely reciprocate;
a driving means which contacts to said precisely actuating means to drive said precisely actuating means; and
a light path conversion means, which is disposed on said precisely actuating means to convert a light path by the precise movement thereof.

34. The projection system according to claim 33, wherein said projection system further comprises a control wave generation means which generates a control wave to control the movement of said precisely actuating means.

35. The projection system according to claim 34, wherein said control wave generation means generates a resultant wave of such a shape that the flat portion of a square wave is linked to the rising portion or the falling portion of a sine wave.

36. The projection system according to claim 35, wherein the flat portion of said combination wave is composed of an upper flat portion and a lower flat portion, each flat portion having at least one step.

37. The projection system according to claim 36, wherein said at least one step is symmetrical to one another at the upper flat portion and the lower flat portion.

38. The projection system according to claim 33, wherein said precisely actuating member comprises
a predetermined plate-shaped support portion;
a first hinge portion of bottleneck structure extending vertically upward, which runs from one end to the other end of said support portion; and
a rotating portion which is linked by said hinge portion to be disposed on said support portion, and precisely reciprocates and rotates left and right on the axis of said first hinge portion.

39. The projection system according to claim 38, wherein said support portion is plural.

40. The projection system according to claim 39, wherein said plurality of support portions are linked up and down by a second hinge portions of bottleneck structure extending vertically upward which runs from one end to the other end of said support portion.

41. The projection system according to claim 40, wherein said second hinge portion is perpendicular to said first hinge portion.

42. The image tilting device according to claim 6, wherein said support portion, said hinge portion, and said rotating portion are made of a material having an elastic restoring force.

43. The image tilting device according to any one of claim 24, wherein said image tilting device further comprises:
a frame of a predetermined height which comprises a protrusion portion at one side for supporting said light path conversion member; and
a supporting member, which is covered at the other side of said protrusion portion of said frame to prevent said light path conversion member from bending.
